(19) United States
(12) Patent Application Publication
(10) Pub. No.: US 2026/0054431 A1
(43) Pub. Date: Feb. 26, 2026

(54) METHOD AND APPARATUS FOR IMPROVED ULTRASONIC FORMATION

(71) Applicant: Soni-Form LLC, Derry, NH (US)

(72) Inventors: Gerald Rocha, Bedford, NH (US); Nicholas G. Lehoullier, Goffstown, NH (US)

(73) Assignee: Soni-Form LLC, Derry, NH (US)

(21) Appl. No.: 19/105,648

(22) PCT Filed: Sep. 1, 2023
(86) PCT No.: PCT/US2023/031869

§ 371 Date: Feb. 21, 2025

Related U.S. Application Data
(60) Provisional application No. 63/403,022, filed on Sep. 1, 2022.
(60) Provisional application No. 63/459,362, filed on Apr. 14, 2023.

(51) Int. Cl. B29C 43/52; B29C 43/22; B29C 43/32; B29C 43/46; B29L 31/00

(52) U.S. Cl. CPC B29C 43/52; B29C 43/224; B29C 43/46; B29C 2043/3266; B29L 2031/729

(57) ABSTRACT

Aspects disclosed herein relate to improvements regarding the formation of touch fasteners on nonwoven materials or other thermoplastic and non-thermoplastic materials employing ultrasonic formation technologies. Such improvements may be applied to rotary sonotrodes or blade sonotrodes. These improvements may include raised or recessed features in the functional surface of the sonotrode, methods and arrangements of pre-heating and/or cooling the functional surface of the sonotrode, varying or fixing the surface speed of the rotary sonotrode relative to a molding roller to form touch fasteners at desired spacing intervals, and the inclusion of supplementary material with the substrate. Various molding rollers are also disclosed.

### CROSS REFERENCE TO RELATED APPLICATIONS

This application claims benefit of U.S. Application Ser. No. 63/403,022, filed Sep. 1, 2022, titled “METHOD AND APPARATUS FOR IMPROVED ULTRASONIC FORMATION”, and claims the benefit of U.S. Application Ser. No. 63/459,362, filed Apr. 14, 2023, titled “METHOD AND APPARATUS FOR IMPROVED ULTRASONIC FORMATION”, each of which is incorporated by reference herein in its entirety.

### FIELD

Disclosed embodiments are related to ultrasonic components and to a method and apparatus for improving the bonding and formation of products processed using ultrasonic technology.

### BACKGROUND

Various types of touch fasteners are commonly used in applications including but not limited to, infant diapers, adult diapers, feminine hygiene products, surgical gowns, wipe cloths, agricultural fabrics, absorbent pads, and other industrial and consumer products. Two common types of touch fasteners include hook and loop fasteners and mushroom and loop fasteners. Hook and loop fasteners typically include a textile strip with numerous monofilament fastener elements shaped like hooks that project from one surface and mate to a complementary textile strip with numerous loop shaped projects. Mushroom and loop fasteners similarly contain complementary textile strips with projected elements, but the fastener element instead contains mushroom shaped heads. There are several processes and methods known to those skilled in the field that are used to produce touch fasteners. These methods include thermoplastic extrusion and molding, thermal bonding using rollers, needle punching and water jet technologies, and ultrasonic formation technologies. Specifically, ultrasonic formation technologies employ energy from ultrasonic vibrations to create friction-like motions, thereby producing heat to allow for forming of a substrate material.

### SUMMARY

According to one aspect of the invention, a system for ultrasonically forming touch fasteners is provided. The system may include a sonotrode having a functional surface and a molding roller having a plurality of fastener cavities. The functional surface of the sonotrode may be configured to apply ultrasonic vibrations to a substrate that is disposed between the functional surface of the sonotrode and the molding roller to form touch fasteners from the substrate. The sonotrode may also have one or more raised and/or recessed features disposed on the functional surface which may be configured to progressively form the touch fasteners from the substrate.

According to another aspect of the invention, a system for ultrasonically forming touch fasteners is provided. The system may include a rotary sonotrode having a functional surface and a molding roller having a plurality of fastener cavities. The functional surface of the rotary sonotrode may be configured to apply ultrasonic vibrations to a substrate that is disposed between the functional surface of the sonotrode and the molding roller to form touch fasteners from the substrate. The rotary sonotrode may include one or more raised and/or recessed features disposed on the functional surface. The rotary sonotrode and molding roller may also be driven in a varied ratio.

### BRIEF DESCRIPTION OF DRAWINGS

Non-limiting embodiments that incorporate one or more aspects of the invention will be described by way of example with reference to the accompanying figures, which are not necessarily drawn to scale. For purposes of clarity, not every component may be labeled in every figure, nor is every component of each embodiment of the invention shown where illustration is not necessary to allow those of ordinary skill in the art to understand the invention. In the figures:

FIG. 1A is a prior art schematic view of one embodiment of a rotary sonotrode apparatus including a molding roller and a substrate;

FIG. 1B is an enlarged schematic view of region 1B of FIG. 1A;

FIG. 1C is a prior art schematic view of one embodiment of a blade sonotrode apparatus including a molding roller and a substrate;

FIG. 1D is a prior art schematic sectional view of another embodiment of a blade sonotrode apparatus including a molding roller;

FIG. 2 is a prior art schematic view of one embodiment of a rotary sonotrode apparatus including a molding roller and a substrate, with intermittent zones of fastener cavities on the molding roller;

FIG. 3 is a schematic view of one embodiment of a rotary sonotrode apparatus with one or more intermittent raised features and including a molding roller and a substrate;

FIG. 4A is a schematic perspective view of one embodiment of a rotary sonotrode apparatus with one or more raised features of different heights;

FIG. 4B is a cross-sectional view of the substrate of FIG. 4A taken along line 4B-4B;

FIG. 5 is a schematic view of one embodiment of a rotary sonotrode and including a molding roll;

FIG. 6 is a schematic view of one embodiment of a rotary sonotrode apparatus containing one or more rollers around the perimeter of a rotary sonotrode and including a molding roller and a substrate;

FIG. 7A is a schematic perspective view of one embodiment of a blade sonotrode apparatus with one or more relief channels and including a molding roller and a substrate;

FIG. 7B is a cross-sectional view of the substrate of FIG. 7A taken along line 7B-7B;

FIG. 7C is a schematic perspective view of one embodiment of a rotary sonotrode apparatus with one or more relief channels and including a molding roller and a substrate;

FIG. 7D is a schematic view of one embodiment of a pattern of undisturbed portions of a substrate;

FIG. 7E is a schematic view of another embodiment of a pattern of undisturbed portions of a substrate;

FIG. 7F is a schematic view of another embodiment of a pattern of undisturbed portions of a substrate;

FIG. 7G is a schematic view of another embodiment of a pattern of undisturbed portions of a substrate;

FIG. 7H is a schematic view of another embodiment of a pattern of undisturbed portions of a substrate;

FIG. 7I is a schematic view of another embodiment of a pattern of undisturbed portions of a substrate;

FIG. 8A is a schematic view of one embodiment of a blade sonotrode;

FIG. 8B is a schematic view of another embodiment of a blade sonotrode;

FIG. 9A is a schematic view of one embodiment of a blade sonotrode;

FIG. 9B is a schematic view of another embodiment of a blade sonotrode;

FIG. 9C is a schematic perspective view of another embodiment of a blade sonotrode;

FIG. 10 is a schematic view of one embodiment of a blade sonotrode apparatus, and showing a molding roller and substrate;

FIG. 11A is a schematic perspective view of one embodiment of a blade sonotrode containing one or more passageways in the sonotrode;

FIG. 11B is a schematic side view of the blade sonotrode apparatus of FIG. 11A and including a molding roller and a substrate;

FIG. 11C is a schematic perspective view of another embodiment of a blade sonotrode containing one or more passageways in the sonotrode;

FIG. 12 is a schematic view of one embodiment of a blade sonotrode apparatus, and showing a molding roller and substrate;

FIG. 13A is a schematic view of another embodiment of a blade sonotrode apparatus, and showing a molding roller and substrate;

FIG. 13B is a schematic view of another embodiment of a blade sonotrode apparatus, and showing a molding roller and substrate;

FIG. 13C is a schematic view of another embodiment of a blade sonotrode apparatus, and showing a molding roller and substrate;

FIG. 13D is a schematic view of a portion of FIG. 13C;

FIG. 14A is a schematic perspective view of one embodiment of a blade sonotrode;

FIG. 14B is a cross-sectional view taken along line 14B-14B of FIG. 14A;

FIG. 15 is a schematic view of one embodiment of a blade sonotrode apparatus bridging across features of the molding roller of FIG. 2;

FIG. 16 is a prior art schematic view of a blade sonotrode apparatus and including a molding roller and a substrate, showing surplus material formed on the substrate;

FIG. 17 is a schematic view of one embodiment of a blade sonotrode apparatus and including a molding roller and a substrate;

FIG. 18A is a schematic perspective view of one embodiment of a blade sonotrode apparatus and including a molding roller;

FIG. 18B is an enlarged radial view of the region 18B of FIG. 18A;

FIG. 18C is a schematic view of one embodiment of a patch of fastener cavities;

FIG. 18D is a schematic view of another embodiment of a patch of fastener cavities;

FIG. 18E is a schematic view of another embodiment of a patch of fastener cavities;

FIG. 19 is a prior art perspective view of one embodiment of a sleeve for mounting onto a roll;

FIG. 20A is schematic view of one embodiment of a rotary sonotrode apparatus, and showing a substrate and a molding roller;

FIG. 20B is a schematic perspective view of the substrate of FIG. 20A exiting the molding roll;

FIG. 21 is a schematic view of an enlarged view of a portion of the rotary sonotrode apparatus of FIG. 20A, and showing a first substrate material;

FIG. 22A is a schematic view of an enlarged view of a portion of the rotary sonotrode apparatus of FIG. 20A, and showing a second substrate material;

FIG. 22B is an enlarged view of region 22B of FIG. 22A;

FIG. 23A is a schematic view of one embodiment of a blade sonotrode apparatus, and showing a substrate and a molding roller;

FIG. 23B is a schematic cross-sectional view of a molding roller including a sleeve secured to a roll;

FIG. 24 is a schematic cross-sectional view of another embodiment of a molding roller;

FIG. 25 is a schematic cross-sectional view of another embodiment of a molding roller; and

FIG. 26 is a schematic view of another embodiment of a molding roller.

### DETAILED DESCRIPTION

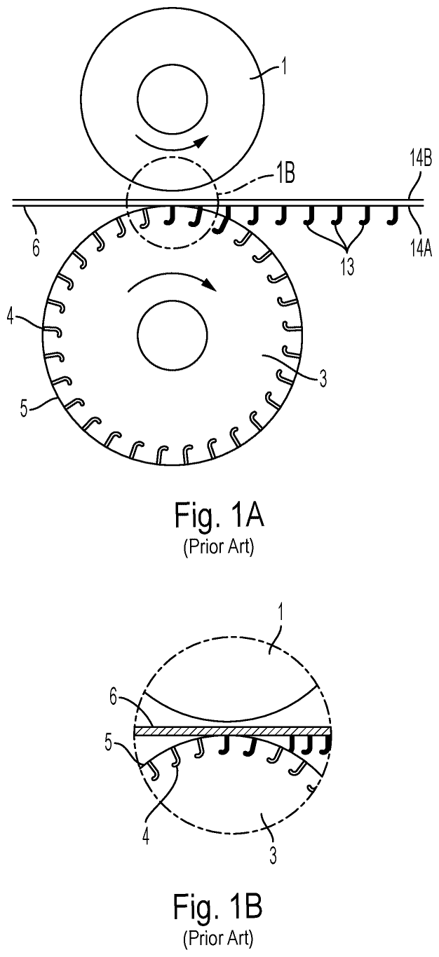

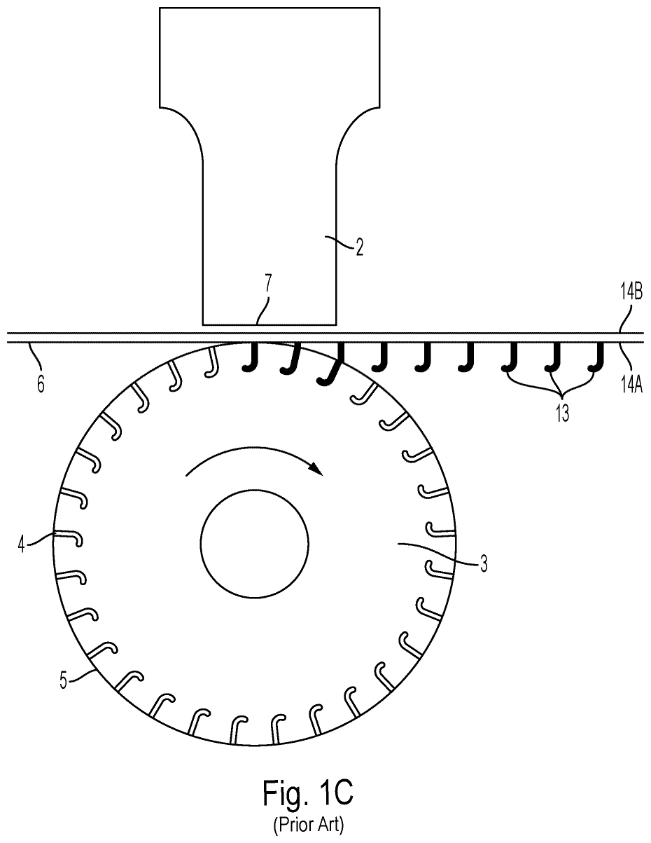

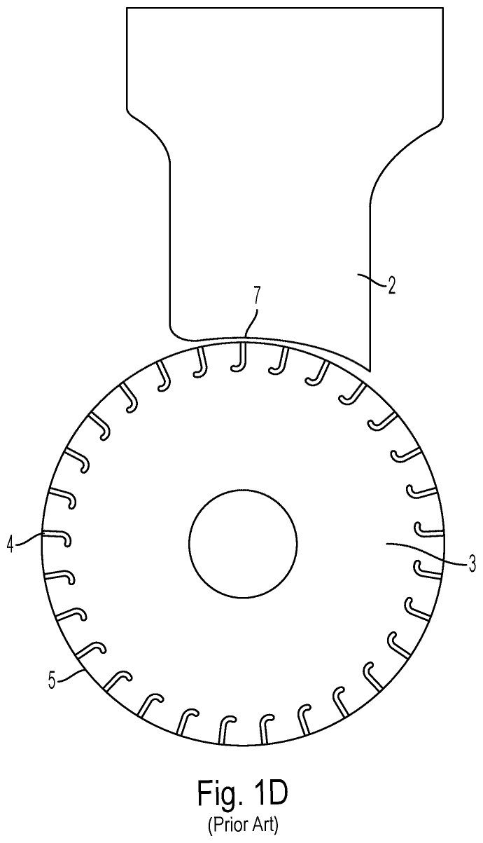

The Inventors have discovered that there are limitations to ultrasonic formation technology in regards to touch fastener production. These limitations are present in the use of both rotary and blade sonotrodes in conjunction with a molding roller to form touch fastener elements from a substrate material. The use of ultrasonic formation technology with a sonotrode apparatus, a molding roller, and a substrate is disclosed in the prior art of U.S. Pat. No. 8,784,722, which is herein incorporated by reference in its entirety. This prior art arrangement discloses use of a rotary sonotrode as shown in FIGS. 1A and 1B, and the use of a blade sonotrode as shown in FIGS. 1C and 1D.

As shown in FIG. 1A, rotary sonotrode apparatus 1 may function by rotating in conjunction with a molding roller 3, wherein the outer perimeter 5 of the molding roller can contain fastener cavities 4. As a substrate material 6 approaches the tangential contact area (i.e., nip) formed by the functional surface of the rotary sonotrode and molding roller (shown in FIG. 1B), compression on the substrate increases due to larger quantities of applied ultrasonic energy in this region. This increased ultrasonic energy induced from ultrasonic vibrations of the rotary sonotrode leads to an increase in heat and pressure applied to the substrate. The substrate material softens due to the applied heat and pressure, allowing some of the material to flow into the fastener cavities on the molding roll side of the substrate 14A, thereby forming portions of the substrate into touch fasteners 13 (or other elements, depending on the shape of the cavities in the molding roller). In this embodiment, the rotary sonotrode side of the substrate 14B does not develop fastener elements since it is not in contact with the fastener cavities. However, in other embodiments, the rotary sonotrode can include cavities for forming the corresponding elements, e.g., the touch fasteners. Further, both the rotary sonotrode and the molding roll can include cavities, which may have the same shape or may have different shapes.

The Inventors have recognized that the use of a rotary sonotrode in the configuration described above inherently limits the effectiveness of the apparatus in softening the substrate, as the limited tangential contact area requires a compressive force of sufficiently high amplitude to create enough heat and pressure necessary to soften the substrate. As such, the Inventors have found that it would be beneficial to increase the dwell time of the substrate under compression. One approach is through increasing the compression zone of the apparatus, which can be achieved by implementing larger diameter sonotrodes or molding rollers. However, this approach may result in increased cost of manufacturing and may have limited effectiveness since a greater amount of energy would be required to operate. Additionally, this approach can be limited by the ultrasonic frequency ranges available due to size constraints of larger diameter sonotrodes or molding rollers.

As an alternative to rotary sonotrodes, a blade sonotrode apparatus 2 can be used in conjunction with a molding roller 3 to soften incoming substrate material through ultrasonic vibrations (FIG. 1C). The blade sonotrodes can be used to overcome the limited contact area issue associated with rotary sonotrodes and can provide a greater dwell time under compression. Specifically, this can be achieved by profiling the functional surface 7 (shown in FIG. 1D) to substantially align the blade sonotrode surface with the molding roller to provide a larger compression zone when applying ultrasonic energy to the substrate. Similarly, the molding roller can contain fastener cavities 4 along the outer perimeter of the molding roller 5 that act to form touch fasteners from portions of the incoming substrate. These blade sonotrode apparatus imparts ultrasonic energy to the substrate by vibrating relative to with the molding roller, which generates a sufficient amplitude of pressure and heat necessary to soften and form the substrate into touch fasteners or other elements, in a manner similar to that described above.

However, the Inventors have recognized that a blade sonotrode configuration as disclosed above has certain limitations resulting from the profiling of the functional surface to achieve a greater dwell time under compression. Due to the sustained ultrasonic energy and friction of the substrate passing through the blade sonotrode apparatus, the functional surface of the blade sonotrode may become excessively hot. If the functional surface becomes excessively hot, the substrate can adhere to the functional surface of the blade sonotrode or become damaged. Certain arrangements can be used to cool the sonotrode surface, as is known to those in the art, such as the implementation of sonotrode materials with limiting heat transfer characteristics, or the use of air or a similar medium to cool the functional surface of the blade sonotrode.

Additionally, a blade sonotrode apparatus may not sufficiently smooth the substrate surface during the forming process, which can generate undesirable artifacts or irregularities in the substrate material post-processing. Specifically, the Inventors have appreciated that during the forming of fastener elements (e.g. hook elements), portions of the elements formed on the substrate by the molding roller may protrude onto the side of the substrate contacting the sonotrode. This may result from entrapped air in the compression zone, which can provide excessive heat to the substrate, thereby making the substrate more vulnerable to distortion and damage. Additionally, the entrapped air may result in microholes to be formed in the substate and these microholes could erupt or break, leaving a roughened surface finish. Artifacts may also occur when the formed hook elements are extracted, resulting in distortions of the substrate surface. In some embodiments, artifacts may take the form of surplus substrate material that can be deposited along the outer edges of the lanes of fastener elements during processing. The Inventors have also appreciated that while artifacts predominantly occur during the formation of fastener elements as disclosed above, artifacts may also result from the composition of the substrate prior to processing. For example, if a composite substrate is used in the application, one or more components of the composite substrate may not soften or melt sufficiently during processing, thereby resulting in artifacts in the substrate surface. While the formation of artifacts resulting from use of blade sonotrodes is discussed, artifacts may also result from the use of rotary sonotrodes. These artifacts can have unwanted effects such as discomfort to the end user in touch fastener applications such as in diapers.

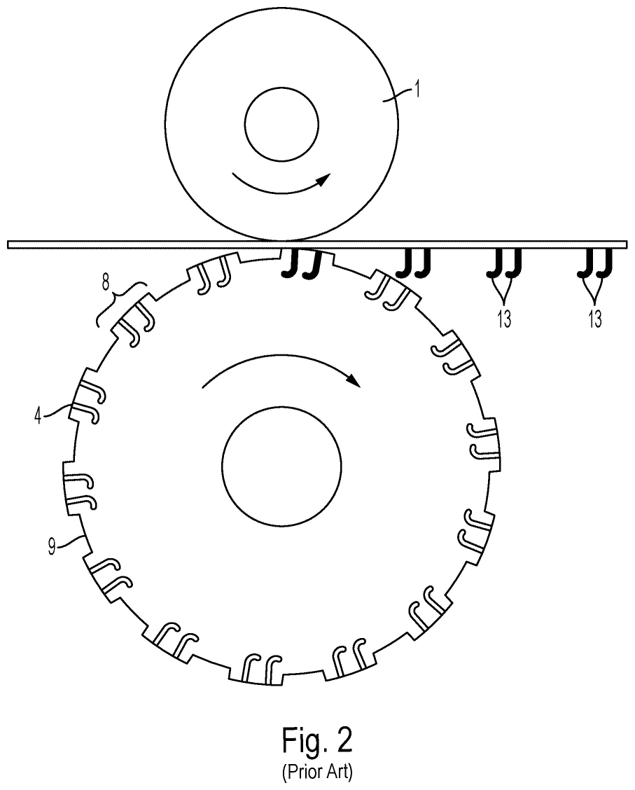

In addition to the prior discussed limitations using ultrasonic formation methods with both rotary and blade sonotrode technologies, there exists limitations in forming intermittent patches of fasteners on a substrate rather than a continuous lane of fasteners. Conventionally, intermittent patches of fasteners can be produced by manufacturing a molding roller with intermittent zones or patches 8 of fastener cavities 4, as shown in the additional prior art embodiment of FIG. 2. In this embodiment, the zones of fastener cavities can be raised above the outer surface of the molding roller 9 to limit the ultrasonic energy subjected to the substrate between zones by a rotary or blade sonotrode.

An additional limitation that may occur is that a lack of material may exist in certain portions of the substrate prior to processing. Any variations in density or mass or thickness of the substrate can affect the forming of fastener elements during the application of ultrasonic energy from the sonotrode to the substrate. While it is possible to increase the average thickness of the incoming substrate material, this may not always be beneficial as only certain regions may have deficient levels of substrate. In addition, increasing the average thickness of the substrate may increase manufacturing costs and may alter the flexibility of the substrate to an unacceptable degree for a given application.

In view of the foregoing, the Inventors have recognized and appreciated that improvements to the rotary and blade sonotrodes can be employed to overcome these deficiencies. It should be appreciated that the concepts disclosed herein may be arranged in any suitable combination, as the present disclosure is not limited in this respect. Further, other advantages and novel features of the present disclosure will become apparent from the following detailed description of various non-limiting embodiments when considered in conjunction with the accompanying figures. The numbered elements disclosed within the figures are maintained throughout the different illustrative embodiments for the sake of clarity. Moreover, commonly used terms disclosed herein are described by the following.

The term “compression zone” is used herein to describe the region of contact area formed by contact of the substrate with a rotary or blade sonotrode and the molding roller, wherein ultrasonic energy is applied to soften the incoming substrate material for forming of fastener elements.

The terms “substrate” or “substrate material” are used interchangeably herein when referring to the material that is fed into the compression zone between the rotary or blade sonotrode and the molding roller. The substrate can comprise any suitable material, although non-woven materials are referenced within this disclosure.

The terms “fastener element” or “touch fastener” are used herein to describe the projections that are formed from the substrate material by applying ultrasonic energy from the sonotrode apparatus to the substrate.

The terms “secondary material” or “supplementary material” are used interchangeably herein when referring to additional material that may be included with the substrate.

The term “functional surface” is used herein when referring to the outer surface of a rotary or blade sonotrode that is at least partially in contact with the incoming substrate material.

The term “molding roller” or “molding roll” is used herein to describe a roller that may comprise a stacked set of rings mounted thereon, with the rings including or defining cavities of a suitable shape (e.g., hook-shaped, pin-shaped, etc). These terms may also be used to describe a screen-like sleeve having cavities which is mounted onto a roller for use in making fasteners (e.g., mushroom-like elements). In the case where the screen-like sleeve is used, the interface between the screen and the roller may allow venting of the cavities while preventing molten or semi-molten polymer or the like from overfilling the cavities. The screen-like sleeve may also be produced in a wider format and in a larger range of diameters in a more economical fashion by comparison to a stacked set of rings which are precisely manufactured to include a certain arrangement of cavities.

The following disclosure relates to methods for improving the formation of touch fasteners on nonwoven materials or other thermoplastic and non-thermoplastic materials employing ultrasonic formation technologies. Aspects disclosed herein may also relate to methods for improving the bonding of these materials, as well as other applications that would benefit from more effective control of the ultrasonic welding or forming process. Also, while this disclosure describes the benefits of improvements to nonwoven materials in great detail, the same benefits may be applied to a broad variety of other materials, such as films, woven fabrics, laminates, elastomerics, thermoplastics as well as non-thermoplastic materials, cotton, paper, metals, foils or combinations thereof. Further, while this disclosure predominantly describes the formation of fasteners such as those used as touch fasteners, the improvements disclosed herein may be used for the formation of hook elements, pins, mushrooms and other features capable of being formed or molded using ultrasonic technology. Additionally, while some embodiments disclosed herein are discussed in reference to either a rotary or blade sonotrode, such improvements may be applied to either type of sonotrode as the disclosure is not limited in this regard. In some embodiments, the fasteners disclosed herein may be formed “progressively”. In particular, a plurality of raised and/or recessed features of a sonotrode may apply ultrasonic vibrations to a substrate that is disposed between a functional surface of the sonotrode and a molding roller to form the fasteners progressively, e.g., the ultrasonic vibrations cumulatively form the resulting fasteners as the substrate progresses through the compression zone.

In some embodiments, a rotary sonotrode can contain one or more intermittent raised features. These features may be implemented to form intermittent patches of fasteners on a substrate rather than a continuous lane of fasteners. It may be desirable to form intermittent patches of fasteners on a substrate for aesthetic or functional purposes such as manufacturing fasteners that can be varied based on desired sizing of adult or infant disposable diapers. These features may also be implemented in applications including incontinence, hygiene, and cleaning products, or any other suitable application where having a continuous lane of fasteners may not desirable.

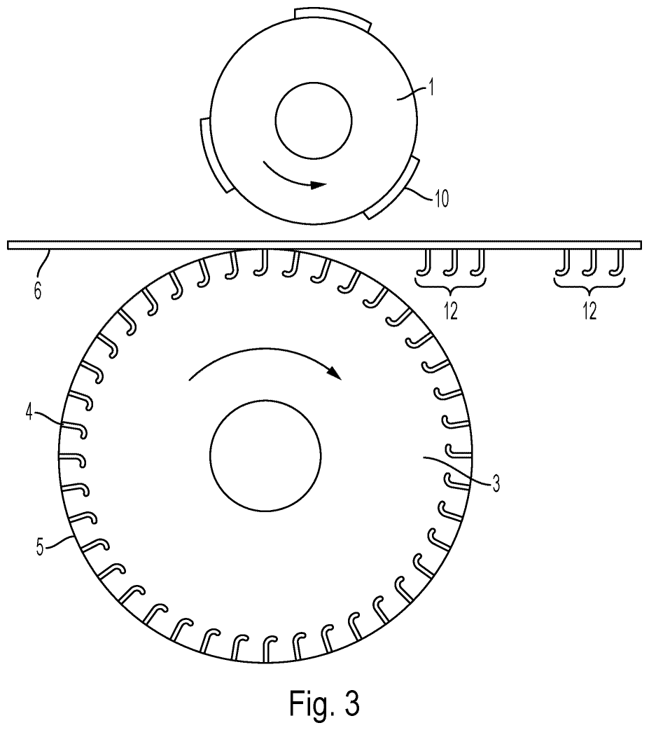

The illustrative embodiment of FIG. 3 shows a rotary sonotrode 1, a molding roller 3, and a substrate material 6. The rotary sonotrode includes intermittent raised features 10 for forming intermittent hook fasteners 12 on a substrate. The hook fasteners may be formed on the substrate as a result of the applied ultrasonic energy in the compression zone between the intermittent raised features of the rotary sonotrode and the molding roller perimeter 5 containing zones of fastener cavities 4. The use of intermittent raised features on a rotary sonotrode may permit use of a molding roller with continuous zones of fastener cavities. In an alternative embodiment, a rotary sonotrode with patches of cavities may be used in conjunction with a plain molding roller or a molding roller having hook cavities.

In some embodiments, the use of intermittent raised features on a rotary sonotrode may provide sections of undisturbed substrate positioned between the zones of fasteners. These substrate portions may not be subjected to the same ultrasonic energy load and pressure as the balance of the substrate, and therefore the materials in these sections may retain their original material properties. The intermittent raised features can be provided on the rotary sonotrode in any suitable configuration as the disclosure is not limited in this regard. As such, the sizing or shape of zones of fasteners or undisturbed substrate portions may be varied for a given fastener application.

In some embodiments, the rotary sonotrode can be actuated using any suitable mechanism including a servo. The actuation of the rotary sonotrode permits the surface speed of the rotary sonotrode to be varied relative to the surface speed of the molding roller. Accordingly, the surface speed of the rotary sonotrode can be greater than, less than, or synchronized with the surface speed of the molding roller to form fastener patches at any desirable spacing interval.

In using a rotary sonotrode for ultrasonic formation of fastener elements, it may be beneficial to control the surface speed of the sonotrode to be synchronized with the surface speed of the molding roller. An example of a molding roller that can be implemented in rotary ultrasonics is an anvil roller, but one of skill in the art would recognize that the use of molding rollers disclosed herein is not limited in this regard. When an anvil roller or other type of molding roller is used in conjunction with a rotary sonotrode to manufacture fastener elements, they may be driven in a fixed ratio through the use of gears mounted to both the rotary sonotrode and molding roller, which can fix the relative rotational speeds of the components during operation. While this specific example discloses use of gearing to provide a fixed rotational speed, other suitable arrangements can be used to drive a rotary sonotrode and molding roller in a fixed or varied ratio.

In some embodiments, the surface speed of the rotary sonotrode may be varied in an intermittent fashion such that the surface speed of the rotary sonotrode is alternated between being greater than, less than, or synchronized with the surface speed of the molding roller in any suitable order thereof. For example, during the formation of touch fasteners, the sonotrode surface speed may be synchronized with the molding roller surface speed. Following the formation of a given set of touch fasteners, the sonotrode surface speed may accelerate or decelerate to form subsequent fastener patches at desired spacing intervals. In such an example, by accelerating or decelerating the sonotrode surface speed, fastener patches may be formed with a smaller or larger spacing interval between the patches, respectively.

In view of the above, the inventors have recognized benefits associated with implementing a molding roller with a variety of continuous fastener cavity patterns disposed thereon in conjunction with a rotary sonotrode in which the surface speed may be varied as disclosed above. In particular, such a configuration may require only a singular molding roller to form a broad variety of touch fastener patches with different spacings between the patches in the machine-direction (MD) or the cross-direction (CD). As used herein, machine-direction refers to the direction where the substrate is fed into the sonotrode for processing while cross-direction refers to the direction that is transverse to the machine-direction. In some embodiments where a molding roller with a variety of patterns disposed thereon is used, the rotary sonotrode may include a variety of raised features and may be driven by any suitable actuator (e.g., a servo) as disclosed herein. In some such embodiments, the spacing of fastener patches in the machine-direction may be controlled by programming of the servo or other actuator to accelerate or decelerate the rotary sonotrode, thereby forming fastener patches with varied spacings as noted above. The spacing of fastener patches in the cross-direction may also be controlled by sliding the rotary sonotrode to a desired cross-directional position corresponding to a region of the molding roller in which a series of touch fasteners are to be formed. Accordingly, the molding roller may have any suitable configuration of patches of fastener cavities disposed along the machine-direction or cross-direction such that corresponding touch fasteners may be formed at any desired spacing interval by varying the rotary sonotrode surface speed or position relative to the molding roller.

In some embodiments, controlling the surface speed of a rotary sonotrode and a molding roller can also improve the formation or filling of fastener cavities by varying the surface speed to ensure that sufficient substrate has accumulated near the zones of fastener cavities prior to applying substantial ultrasonic energy to that portion of the substrate. Additional features can be included on the functional surface of a rotary sonotrode such as ribs, grooves, bumps, pockets, or any other suitable feature, which may also be included in linear or non-linear configurations to apply ultrasonic energy to select regions of the substrate. In a further embodiment, both rotary sonotrode surface features and variance in sonotrode surface speed can be employed to assist in the filling or formation of fastener cavities. By varying the surface speed and features of a rotary sonotrode, directional forces can develop in the process of applying ultrasonic energy to the substrate, which can direct softened material into the machine-direction, cross-direction, or other direction of the sonotrode to enhance filling of fastener cavities or to enhance physical properties of the processed substrate. This process of selectively forming portions of the substrate into the fastener cavities is herein referred to as “gathering” the substrate. Gathering the substrate may be beneficial in the use of a rotary sonotrode for forming fastener elements because it allows the mass of incoming substrate material to be increased selectively where fasteners are being formed, which reduces or eliminates the need to increase the mass of the entire substrate material. Some examples of gathering can be found in U.S. Pat. No. 10,953,592, which is herein incorporated by reference.

The Inventors have discovered that, as a result of directional forces induced from varying the rotary sonotrode surface speed and providing external features along the surface of the sonotrode, portions of the substrate material may be subjected to shearing forces during processing. These shearing forces can affect the molecular orientation of the substrate post-processing which can provide several beneficial features. The induced shear forces may provide textural differences, aesthetic differences, or increase tensile strength in the end product in certain embodiments wherein shearing results in an advantageous molecular orientation of the substrate. These shear forces may further provide additional heat input to the substrate, which would lower the viscosity of the substrate material during processing, thereby allowing for easier filling of fastener cavities to form fastener elements.

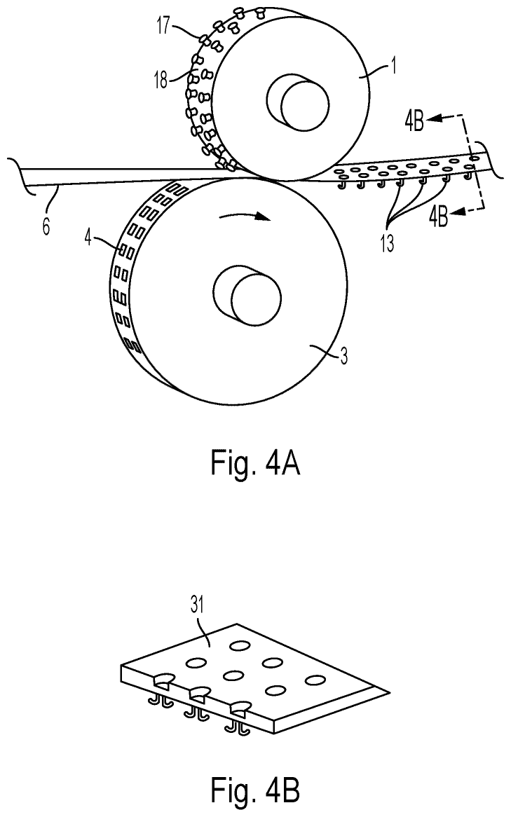

In some embodiments, the functional surface of a rotary sonotrode 1 can include raised features 17 on the surface 18 of the rotary sonotrode, as shown in an illustrative embodiment of FIG. 4A. In some embodiments, the raised features 17 may all have the same height from the surface 18 or may have differing heights. These raised features on the surface of the sonotrode may also be of sufficient height to prevent the functional surface of the sonotrode from applying substantial ultrasonic energy to the entirety of the substrate. The illustrative embodiment of FIG. 4A also includes a molding roller 3 with zones of fastener cavities 4 for use in forming touch fasteners 13 (e.g. hook elements) on a substrate 6. The raised features 17 can be ribs, pads, bumps, graphical designs, logos, or any other suitable configuration of shapes. In some embodiments, the surface of the sonotrode may include recessed features, such as pockets or grooves, of the same or differing depths. The ultrasonic energy may be applied to the substrate at the portions of the sonotrode that contact the substrate, therefore selectively creating fastener elements at these locations. The ultrasonic energy applied from these features may also create recesses in portions of the substrate on the side facing the sonotrode. The Inventors have recognized that the use of raised and/or recessed features may also result in less energy being required to operate the sonotrode, which can provide a more efficient manufacturing process.

When a rotary sonotrode with raised or recessed features is used to ultrasonically form touch fastener elements from a substrate, undisturbed portions of substrate may exist. The illustrative embodiment of FIG. 4B shows processed substrate material that contains undisturbed portions on the side 31 of the substrate facing the rotary sonotrode. The substrate material may be, for example, non-woven material which can retain its original material characteristics in the undisturbed portions of substrate post processing. In some embodiments, the substrate material with undisturbed portions may also contain formed fastener elements on the side of the substrate facing the molding roller resulting from selectively applying ultrasonic energy from the raised or lowered features. In other embodiments, however, the substrate material may include undisturbed portions and formed fastener elements on the same side of the substrate.

In some embodiments, a secondary material can be added in a rotary sonotrode apparatus by feeding the secondary material between the rotary sonotrode and the substrate or the substrate and the molding roller. The secondary material can be fed into the compression zone continuously or intermittently. Any suitable thermoplastic or non-thermoplastic secondary material can be used, including but not limited to polypropylene, nylon, polyethylene, polyester, acetate, paper, cotton, foils, metals, or glass. In a further embodiment, the rotary sonotrode may include features that permit the patches of secondary material to be accurately positioned during processing. Such features include use of a vacuum, mechanical arrangements such as pins, or surface features on the sonotrode, but any suitable features for accurately positioning the secondary material may be used as the disclosure is not limited in this regard.

In a further embodiment, the secondary material may take the form of a film or web of material. This material can be similarly fed continuously or intermittently into the compression zone between the sonotrode and molding roller to act as supplementary material for filling zones of fastener cavities that may lack material. When using a rotary sonotrode with raised features, portions of the secondary material may be selectively incorporated into regions of the substrate where fasteners are being formed. As disclosed herein, use of raised features on a rotary sonotrode can retain portions of the substrate to be undisturbed. In such an embodiment, the incorporation of secondary material may result in a surplus of material on the surface of the substrate post-processing. In some embodiments, this surplus material may be removed to only retain the secondary material used in supplementing the substrate in the fastener cavities. The excess material may additionally be recycled in certain embodiments.

In some embodiments, secondary material or multiple materials may be coated onto raised features of a rotary sonotrode. Such secondary materials may include but are not limited to adhesives, polymers, and inks. The incorporation of these materials on raised features of the rotary sonotrode may permit the printing or compression of patterns onto the sonotrode side of the substrate during the ultrasonic formation of the fastener elements. As disclosed herein, there are significant amounts of heat and pressure associated with ultrasonic formation methods of fastener elements. In some embodiments, the heat and pressure can be used to assist in drying, curing, or converting the secondary material to aid in the product of the fastener elements. For example, a thermoplastic secondary material can be used to at least partially penetrate a non-thermoplastic substrate material such as cotton or paper to permit the forming of the secondary material with the substrate material. Such an embodiment would permit usage or more environmentally friendly substrate materials. While the use of secondary materials has been disclosed in reference to rotary sonotrodes, the inventors have recognized that secondary materials may also be used with blade sonotrodes, as is discussed in greater detail below.

In some embodiments, the functional surface of a rotary sonotrode can include a curved surface in the form of grooves or berms. The Inventors have found that these features can be implemented to enhance filling of the fastener cavities when forming fastener elements from a substrate material using ultrasonic formation methods. Benefits from providing grooves or berms in the functional surface of a rotary sonotrode include, but are not limited to, increased throughput speed during processing, reduced occurrence of holes or damage in the processed substrate, and a more uniform distribution of substrate material during processing. The Inventors have recognized that the use of grooves or berms can be also incorporated into a blade sonotrode apparatus, as is disclosed further below.

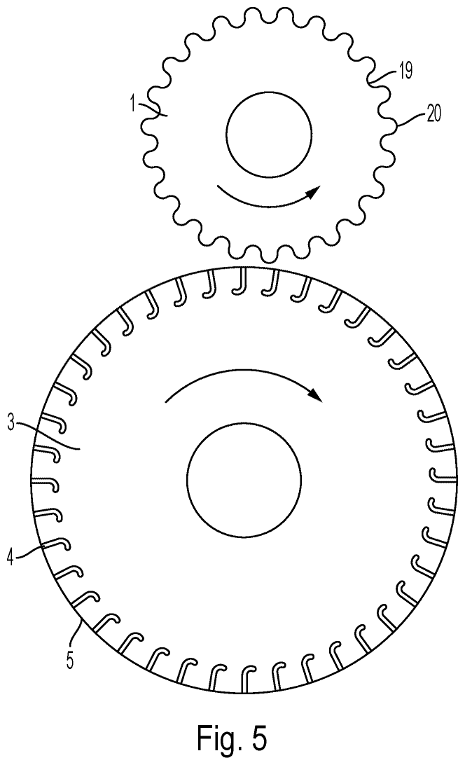

The illustrative embodiment of FIG. 5 shows the implementation of linear grooves 19 and raised berms 20 in the functional surface of a rotary sonotrode apparatus 1. This illustrative embodiment also includes a molding roller 3 with an outer perimeter 5 containing zones of fastener cavities 4. The one or more grooves and berms can be configured in a cross-direction and may be adjacent to one another, as shown in FIG. 5. The raised berms 20 may permit the application of ultrasonic energy to be focused locally in a similar manner to energy directors used in plunge ultrasonic welding of molded thermoplastic components. However, unlike these aforementioned traditional energy directors, the raised berms 20 when used in conjunction with adjacent grooves 19 serve to create a series of reservoirs in the functional surface of the rotary sonotrode which may contain gathered substrate. Substrate materials, including but not limited to nonwoven materials, often have variation in density or mass throughout the material. Since a portion of the mass of the substrate is used to form fastener elements, any variation in mass of the incoming substrate may result in holes on the finished product or missing or partially filled fastener cavities during processing. The gathered substrate in the reservoirs formed by the grooves 19 and berms 20 can serve to supplement low-mass portions of substrate material during processing. As disclosed herein, the surface speed of the rotary sonotrode can be varied to induce shear forces, which can assist in distributing the gathered substrate to provide a more uniform substrate material during processing.

The inventors have found that, in some embodiments, the use of certain surface finishes or textures in a rotary and/or blade sonotrode may serve to reduce friction applied to the substrate material. For example, some or all of the functional surface of a rotary and/or blade sonotrode may have a satin finish or a polished finish. In some embodiments, the functional surface of a rotary sonotrode or raised features on the rotary sonotrode may be textured to assist in the ultrasonic formation of fastener elements. The Inventors have found that a textured surface finish ranging from 0.7-micron Ra to 1-micron Ra, wherein Ra is the roughness average of a given surface, may be beneficial in reducing adhesion of substrate material to the functional surface of a rotary sonotrode. While this range of Ra values is disclosed, a textured surface finish with any suitable roughness average may be used including greater than or equal to 0.001-micron Ra, 0.01-micron Ra, 0.1-micron Ra, 0.5-micron Ra, 0.6-micron Ra, 0.7-micron Ra, 0.8-micron Ra, 0.9-micron Ra, 1-micron Ra, 1.1-micron Ra, 1.2-micron Ra, 1.3-micron Ra, 1.5-micron Ra, 2-micron Ra, 3-micron Ra, 5-micron Ra, 7-micron Ra, 10-micron Ra, 12-micron Ra, or greater. The use of a textured surface on a rotary sonotrode can also permit cooling of the functional surface. Without wishing to be bound by theory, this may be caused by the textured surface providing pathways for the hot, trapped air to escape the compression zone between the rotary sonotrode, molding roller, and substrate prior to or during the ultrasonic formation process. As will be apparent to those of skill in the art, textures can be applied the rotary sonotrode using any suitable method including, but not limited to, electric discharge machining, electro-chemical machining, chemical or mechanical etching, grit blasting, electroplating, laser engraving, and spray coating. The Inventors have recognized that the use of textured surfaces with any suitable roughness average can be also incorporated into a blade sonotrode.

In another example, one or more grooves may be disposed on a rotary and/or blade sonotrode and only the grooves may have a similar satin or polished finish. Such configurations may serve to reduce applied friction to portions of the substrate during processing as a result of reduced surface roughness on the portion of the functional surface contacting the substrate.

In some embodiments, the rotary sonotrode apparatus may be cooled using a variety of methods known to those skilled in the art to avoid the substrate material from adhering to the functional surface of a rotary sonotrode or to avoid damage to the substrate. Such cooling methods include, but are not limited to, use of cooling air provided by blowers, compressed air, chilled compressed air, vortex cooling nozzles, or cryogenics. The rotary sonotrode may be externally cooled or may be cooled by passing a cooling medium including, but not limited to compressed air, gases, or other fluid through cooling channels that can be machined into or onto the rotary sonotrode.

In some embodiments, the incoming substrate material may be preheated before being subjected to ultrasonic energy for the formation of fastener elements. Preheating the substrate material can soften the substrate material prior to processing and may result in higher thruput speed and provide easier forming of the substrate into the fastener cavities. As will be apparent to those skilled in the art, the incoming substrate material may be pre-heated using any suitable method including, but not limited to, hot air, infrared, radio frequency, and contact heating.

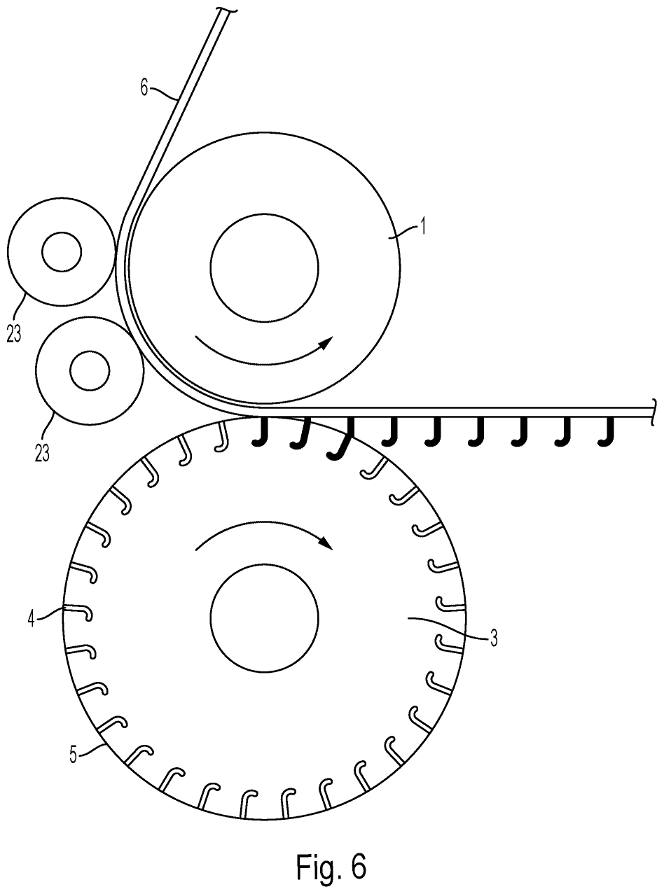

As shown in the illustrative embodiment of FIG. 6, one or more rollers 23 may be positioned around the perimeter of the rotary sonotrode 1 to provide contact pressure with incoming substrate 6 against the rotary sonotrode. The rollers may be positioned to allow contact with the substrate prior to the substrate contacting the molding roller 3, which pre-heats the substrate material prior to the formation of fastener elements. In such an embodiment, the substrate material is preheated or softened prior to experiencing a sufficiently high amplitude of ultrasonic energy and pressure from the rotary sonotrode, allowing for easier formation of the substrate material into the fastener cavities 4 located along the perimeter of the molding roller 5.

In some embodiments, the rotary sonotrode may be cantilevered or supported at both ends. The rotary sonotrode may also be driven using any commonly available ultrasonic frequency range, as the disclosure is not so limited. In some embodiments, a suitable ultrasonic operating frequency of the rotary sonotrode may be greater than or equal to 1 kHz, 2 kHz, 5 kHz, 10 kHz, 15 kHz, 20 kHz, 25 kHz, 30 kHz, 35 kHz, 40 kHz, 45 kHz, 50 kHz, 60 kHz, 70 kHz, 80 kHz, 90 kHz, 100 kHz, 110 kHz, 120 kHz, or greater. In some embodiments, however, a preferred range of operating ultrasonic frequencies of a rotary sonotrode is between 5 and 100 kHz. During operation of the rotary sonotrode at a predetermined ultrasonic frequency, the sonotrode may expand and contract radially, resulting in the generation of heat due to friction, thereby softening the substrate. A blade sonotrode may also be driven at any suitable ultrasonic frequency during operation such that the blade sonotrode may expand and contract to generate heat to soften the substrate.

In some embodiments, the rotary sonotrode may be of any suitable dimensional parameters to achieve an ultrasonic wave during operation of the sonotrode that is of a half wavelength, a full wavelength, or any multiple thereof. In some such embodiments, use of these wavelength increments may serve to promote resonance of the rotary sonotrode during operation, thereby imparting ultrasonic energy to the substrate. In some embodiments, the rotary sonotrode may be of a diameter greater than or equal to about 20 mm, 50 mm, 75 mm, 100 mm, 150 mm, 200 mm, 250 mm, 300 mm, 350 mm, 400 mm, 450 mm, 500 mm, 600 mm, 700 mm, or greater. Combinations of the above referenced ranges are also possible. For example, a rotary sonotrode may have a diameter of about 75 mm and an ultrasonic frequency of 40 kHz. In another example, a rotary sonotrode may have a diameter of about 150 mm and an ultrasonic frequency of 20 KHz. While the disclosure above has discussed improvements to a rotary sonotrode in great detail, improvements may also be applied to blade sonotrodes to overcome the aforementioned limitations. As priorly discussed, blade sonotrodes have been used in prior art arrangements to provide greater dwell time on the substrate under compression to address the issue of rotary sonotrodes having a limited tangential contact area with the substrate. Blade sonotrodes also have limitations as disclosed above including, but not limited to, artifacts that can form on the substrate post-processing and excessive heat associated with the blade sonotrode functional surface. While the formation of artifacts is discussed in reference to blade sonotrodes, artifacts may also occur on the substrate postprocessing by using rotary sonotrodes.

In some embodiments, a blade sonotrode can contain one or more reliefs or channels. These features may be implemented to allow portions of the substrate material to pass through the compression zone between the blade sonotrode and molding roller without subjecting said substrate portions to the same ultrasonic energy load as the balance of the substrate. It may be desirable to maintain these undisturbed portions in the substrate to retain the substrate material characteristics prior to processing. For example, if a non-woven substrate material is used in conjunction with reliefs or channels in the blade sonotrode surface, the soft undisturbed portions can serve to protect the end user from abrasion or discomfort resulting from raised artifacts that may be present in the postprocessed substrate. The Inventors have found that these raised artifacts may be present in the post-processed substrate as a result of displacement of substrate materials that may protrude slightly above the substrate surface. The undisturbed portions may be useful to address discomfort associated with such artifacts in applications including, but not limited to, adult and infant disposable diapers.

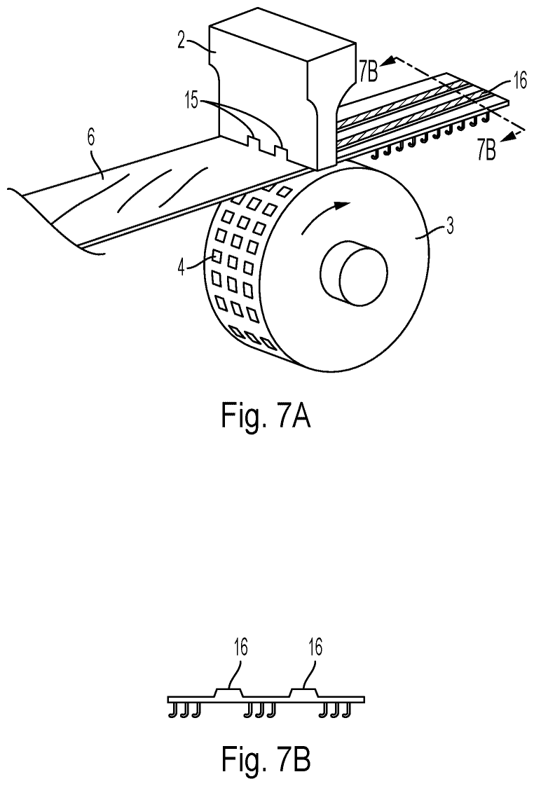

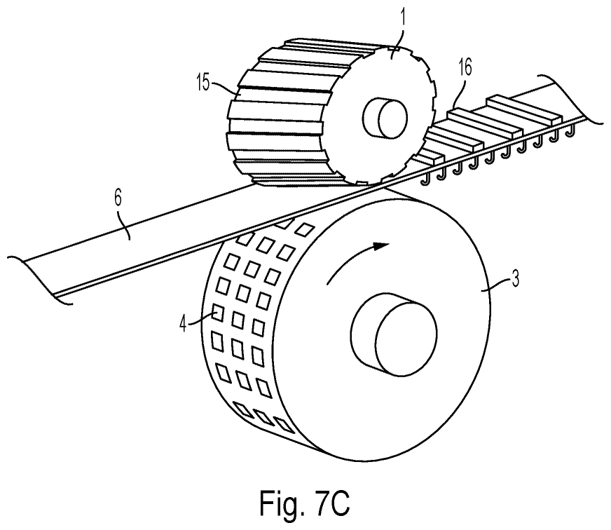

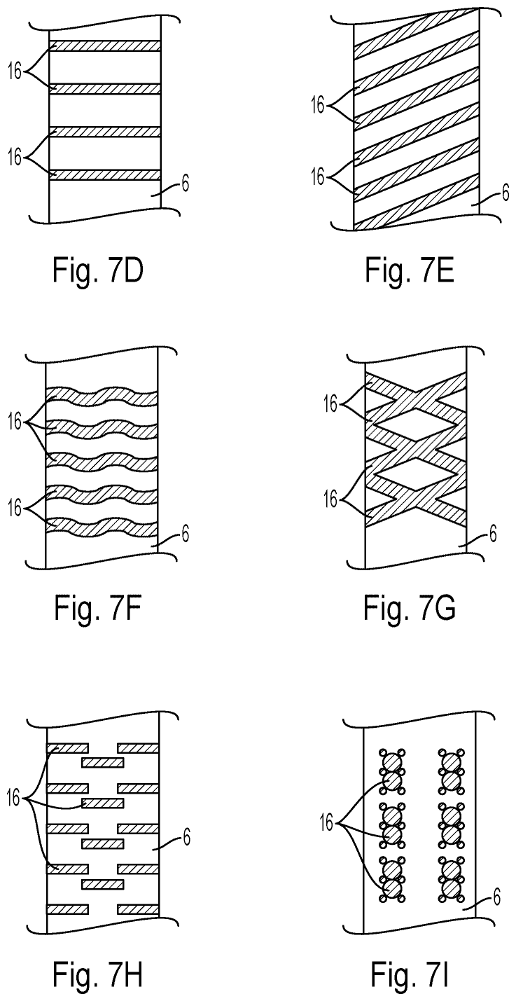

The illustrative embodiment of FIG. 7A shows a blade sonotrode 2, a molding roller 3, and a substrate material 6. The molding roller 3 includes a zones of fastener cavities 4 located around the perimeter of the molding roller 3. The blade sonotrode includes one or more reliefs of channels 15 that allow portions of the incoming substrate to pass through the compression zone while being subjected to minimal ultrasonic energy load, therefore resulting in minimally disturbed or undisturbed portions of substrate material 16 post-processing. These portions of substrate are further shown in the illustrative embodiment of FIG. 7B, which shows a cross-section view of the substrate of FIG. 7A. The number of undisturbed portions post-processing can be controlled by adding more reliefs or channels in the functional surface of the blade sonotrode. The desired sizing of the undisturbed portions post-processing may also be controlled by changing the dimensional parameters associated with the reliefs or channels. Further, the one or more reliefs or channels can be of varying or equal profiles. As described above, these undisturbed portions can serve to protect the end user from discomfort resulting from raised artifacts in the post-processed substrate surface, but the benefits of providing undisturbed portions in the substrate surface are not limited in this regard. The same functionality may be provided when using a rotary sonotrode with channels provided in the sonotrode functional surface to produce undisturbed portions, as detailed below.

The illustrative embodiment of FIG. 7C shows a rotary sonotrode 1, a molding roller 3, and a substrate material 6. The molding roller 3 includes zones of fastener cavities 4 located around the perimeter of the molding roller 3. The rotary sonotrode 1 includes one or more reliefs or channels 15 that allow portions of the incoming substrate to pass through the compression zone while being subjected to minimal ultrasonic energy load, therefore resulting in minimally disturbed or undisturbed portions of substrate material 16 post-processing.

The embodiments of FIGS. 7D-I illustrative various embodiments of patterns of undisturbed portions 16 of substrate 6 that may be formed by altering the functional surface of the rotary sonotrode 1 to include reliefs or channels 15 with different profiles. FIG. 7D shows the resulting undisturbed portions 16 of substrate 6 that are formed by the profile of channels 15 depicted in FIG. 7C. Specifically, the channels 15 of FIG. 7C are formed perpendicular to the direction of incoming substrate 6, and as such, the resulting undisturbed portions 16 of FIG. 7D are formed in a rectangular pattern perpendicular to the direction in which the substrate 6 is fed into the compression zone. In FIGS. 7E and 7F, the resulting undisturbed portions 16 of substrate 6 are shown to include angled and wavy patterns, respectively. In FIGS. 7G and 7H, the resulting undisturbed portions 16 are shown as being formed in a crosshatch pattern and a staggered pattern, respectively. Moreover, FIG. 7I shows an embodiment where the resulting undisturbed portions 16 may be formed as a logo. While in the embodiment of FIG. 7I the logo is shown as a plurality of features having a “teddy bear” appearance, any suitable type of logo may be formed from undisturbed portions of substrate material as the disclosure is not so limited. While these examples of patterns of undisturbed portions of substrate are disclosed above, any suitable pattern may be formed from the substrate by altering the functional surface of a rotary and/or blade sonotrode.

In one embodiment, the undisturbed portions 16 of substrate material may serve to enhance penetration of adhesives applied to the substrate surface. Such a configuration may occur due to the fibrous nature of some undisturbed substrate materials (e.g. nonwoven or paper material), which may provide easier adhesion in comparison to a film-like surface provided by molded substrate material. The use of adhesives may permit attachment of the substrate to other materials through modes including, but not limited to, adhesive bonding or encapsulation of fibers. This use of adhesives with undisturbed portions of substrate may be particularly beneficial if the substrate is comprised of a material that is difficult to bond to including, but not limited to, polyolefins, silicones, and polyamides.

In a further embodiment, the undisturbed portions of substrate may be compressed to decrease the thickness of the substrate or to increase the density of the substrate in select areas. The increased density may result in increased tensile strength for a given substrate. The sizing of the undisturbed portions can also be selectively adjusted by altering the height of the reliefs or channels in the sonotrode surface. In such a configuration, the reliefs or channels may serve to provide sufficient ultrasonic energy to compress the undisturbed portions while not providing a sufficient amplitude of energy necessary to melt the undisturbed portions.

As disclosed herein, channels may provide undisturbed portions on the substrate. Specifically, in some embodiments, undisturbed portions of substrate may be provided on the same side as the formed fastener elements. This may be beneficial to increase the flexibility of the post-processed substrate. In such a configuration, however, the undisturbed portions may interfere with the with the engagement of formed fastener elements and corresponding loop-like materials traditionally used in the art for fastener applications. As such, in some embodiments, the post-processed substrate may contain fastener elements positioned above the undisturbed portions of the substrate, which may be readily engageable with a mating material such as loop-like materials.

In some embodiments, the functional surface of a blade sonotrode can include a curved surface in the form of grooves or berms. As disclosed above for a rotary sonotrode, the Inventors have also found that grooves or berms in the functional surface of a blade sonotrode can be implemented to enhance filling of fastener cavities, to increase thruput speed during processing, to reduce occurrence of holes or damage in the processed substrate, and to provide a more uniform substrate distribution post-processing.

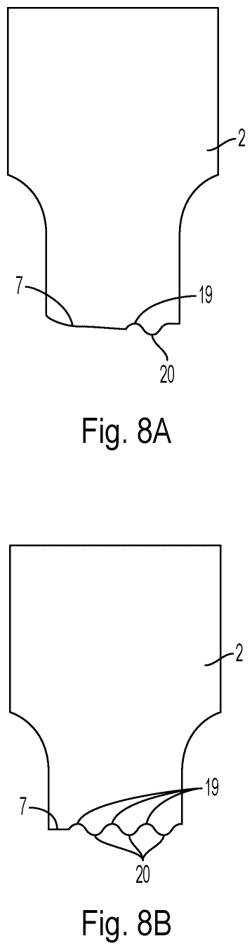

In the illustrative embodiments of FIGS. 8A and 8B, the blade sonotrode 2 can contain one or more grooves 19 or raised berms 20 incorporated into the functional surface 7 of the blade sonotrode. These grooves and berms may be applied in both a flat and curved blade sonotrode functional surface. The incorporated berms may serve to direct the ultrasonic energy over a smaller applied area, which may improve the transfer of ultrasonic energy from the blade sonotrode to the substrate. The grooves, in conjunction with adjacent berms, may serve to gather portions of the softened substrate and to act as reservoirs for use in supplying material to select low density areas of the incoming substrate.

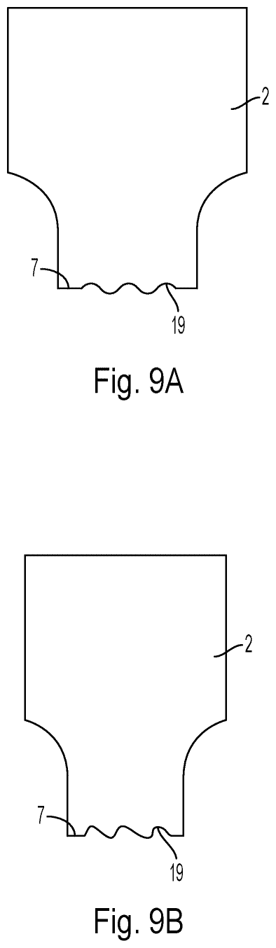

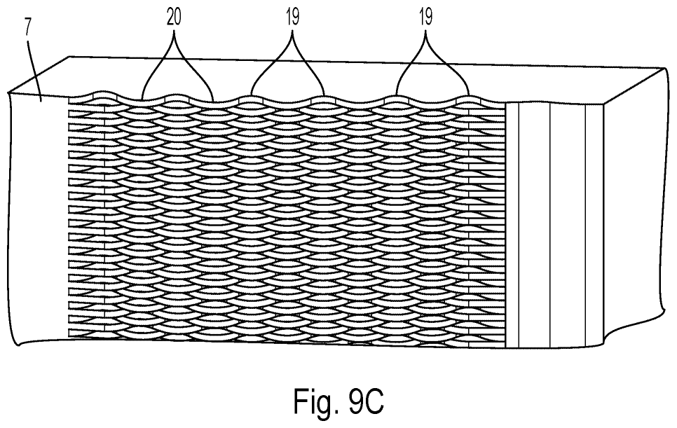

In the further illustrative embodiments of FIGS. 9A and 9B, the grooves 19 in the functional surface 7 of a blade sonotrode 2 may be symmetrical side surfaces (as shown in FIG. 9A) or have asymmetrical side surfaces (as shown in FIG. 9B). It may be beneficial to implement asymmetrical grooves in the functional surface of a blade sonotrode to create a downward vector of force on the softened substrate material that may be gathered in the one or more grooves in the functional surface. The downward vector of force may be created by the ramp-like nature of the asymmetrical grooves that lead to adjacent berms in the functional surface. The applied downward vector of force can serve to provide greater pressure on the substrate which can enhance the filling of fastener cavities.

While various embodiments of continuous raised and/or recessed features in rotary and/or blade sonotrodes have been disclosed above, in some embodiments, raised and/or recessed features may be formed in a non-continuous fashion in the sonotrode functional surface. Such non-continuous features may be formed as non-continuous channels, grooves, berms, or any other suitable feature as the disclosure is not so limited. As used herein, the term “continuous” is used to describe raised and/or recessed features that extend the entire duration of the functional surface of a rotary and/or blade sonotrode while the term “non-continuous” is used to describe raised and/or recessed features that do not extend the entire duration of the functional surface of a rotary and/or blade sonotrode. Further, such continuous or non-continuous features may be formed in the machine-direction, the cross-direction, or any other suitable direction on the sonotrode functional surface as the disclosure is not so limited.

The inventors have recognized that the use of non-continuous features such as non-continuous channels, grooves, and/or berms in the sonotrode functional surface may serve to reduce the contact area between the substrate and the sonotrode, thereby reducing drag and the force necessary to compress the substrate. As disclosed herein, drag may induce unwanted distortion and other artifacts in the post-processed substrate and as such, benefits may be realized by providing non-continuous raised and/or recessed features to create a more uniform post-processed substrate. Moreover, the inventors have found that certain formations of continuous features (e.g., continuous channels formed in the cross-direction) may undesirably result in portions of the substrate being bunched within the continuous features, thereby creating disturbances in the post-processed substrate. As such, the inventors have recognized that certain configurations of non-continuous features may serve to reduce the tendency of the substrate to bunch while reducing the compression on the substrate.

Non-continuous features disposed on the functional surface of a rotary and/or blade sonotrode may be formed in any suitable fashion as the disclosure is not so limited. In some embodiments, the non-continuous features may include non-continuous channels, grooves, and/or berms as disclosed above. Without wishing to be bound by theory, the non-continuous features may be formed in any suitable pattern. For example, in some embodiments, a plurality of grooves and berms may be provided in the functional surface of a blade sonotrode, and the plurality of grooves and berms may be formed in a staggered pattern such that each groove and berm is offset with respect to one another throughout the duration of the sonotrode functional surface. In particular, the inventors have found that a staggered pattern may serve to periodically alternate between providing relief and compression to the incoming substrate as it is processed while not allowing the substrate to bunch within the non-continuous features.

FIG. 9C shows a schematic perspective view of a blade sonotrode functional surface 7 having a plurality of grooves 19 and berms 20 which are formed in a staggered pattern along the machine-direction such that each row of grooves 19 and berms 20 are offset from a subsequent row. As noted above, such a configuration may serve to reduce the tendency of the substrate to bunch while being processed. Moreover, while the embodiment of FIG. 9C depicts a plurality of grooves 19 and berms 20 formed in a staggered pattern in the machine-direction, in other embodiments such a pattern may be formed along the cross-direction or any other suitable direction as the disclosure is not so limited.

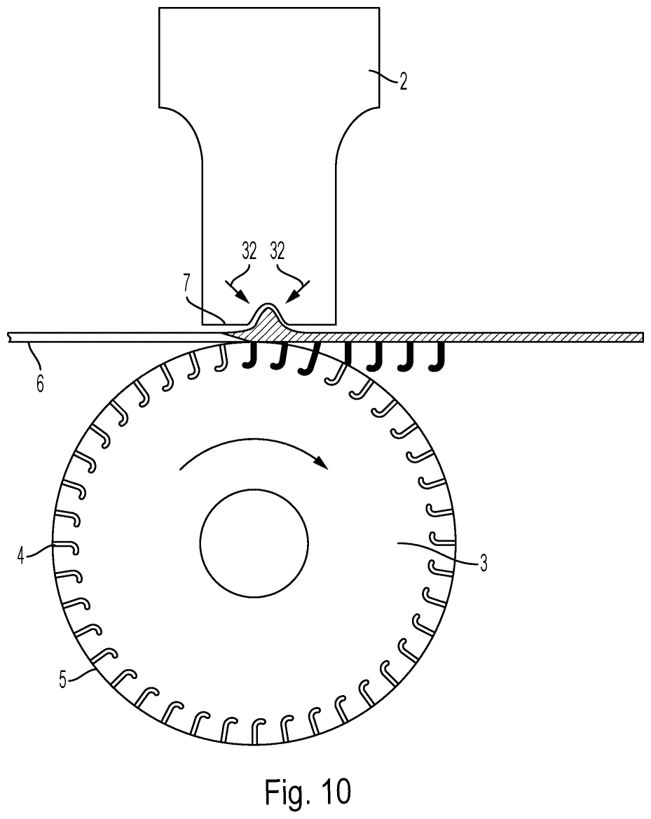

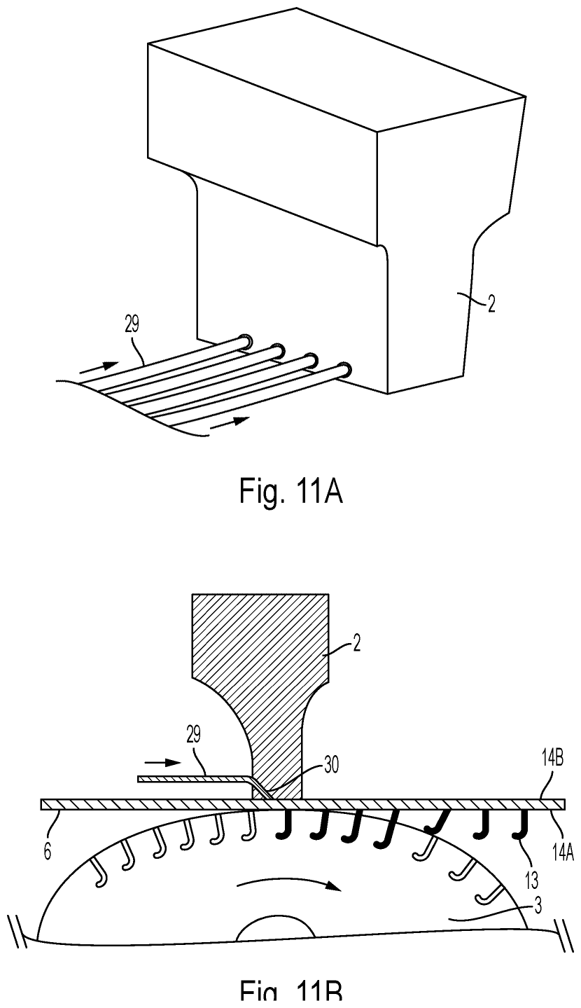

In the illustrative embodiment of FIG. 10, a blade sonotrode 2 with a functional surface 7 is shown in conjunction with a molding roller 3 having zones of fastener cavities 4 along the outer perimeter of the molding roller 5. As shown in FIG. 10, one or more grooves may be provided in the functional surface of the sonotrode to create downward force vectors 32. These downward force vectors are shown to apply forces from the side surfaces of the groove to the gathered substrate in the reservoirs. In one embodiment, the radii of the grooves or berms may range between 0.125 mm to 30 mm, and the radii of the grooves or berms can be individually varied. The grooves or berms may be employed in a flat or curved functional surface of a blade sonotrode. In such a configuration, the grooves or berms may be employed to selectively apply force and ultrasonic energy to the substrate as it proceeds through the compression zone.

In some embodiments, a secondary or supplementary material can be added in a blade sonotrode apparatus by feeding the material through passageways that may be located within or as a part of a blade sonotrode. The supplementary material may include, but is not limited to, monofilaments, fluids, ribbons, or thermoplastic and non-thermoplastic materials. In a further embodiment, the supplementary materials may include metallic materials, including but not limited to, wires to provide electrical shielded or magnetic properties to the processed substrates.

In some embodiments, supplementary materials may be used as filler material to supplement deficient portions of substrate that have variations in density and mass. In some such embodiments, the addition of supplementary materials may alter the structure of the substrate post-processing. In addition or alternatively, the addition of supplementary materials may be used to change the functional characteristics of the substrate material post-processing. For example, supplementary materials may be added that increase or decrease the flexibility of the post-processed substrate, e.g., through use of supplementary materials such as elastomers. While this example is disclosed, any suitable functional characteristics of the substrate material may be altered through the addition of supplementary materials including, but not limited to thermal properties, electrical properties, magnetic properties, chemical properties, optical properties, and/or physical properties (e.g., the amount of mechanical stress that is able to be applied to the substrate through bending, stretching, folding, creasing, etc).

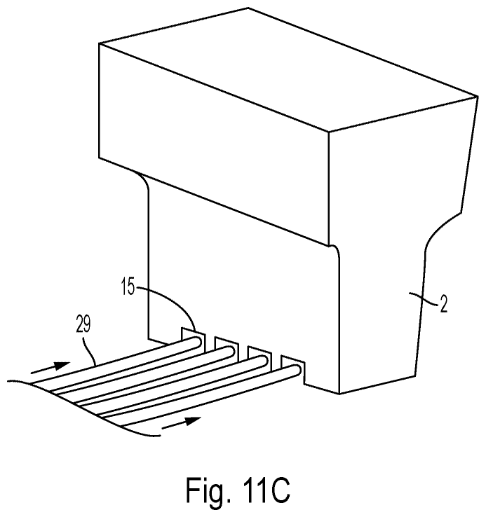

In the illustrative embodiment of FIGS. 11A and 11B, such one or more supplementary materials 29 can be guided through one or more corresponding passageways 30 to locations within the blade sonotrode apparatus 2. These passageways can be employed to enhance the filling of fastener cavities with the incorporation of the supplementary material. This may be beneficial since the incoming substrate 6 may have variations in density and mass, and therefore the provided supplementary material can assist in filling select fastener cavities to achieve more uniform substrate material and fastener elements 13 post-processing. The passageways may function to accurately position the supplementary material in the compression zone where the blade sonotrode is applying ultrasonic energy to the incoming substrate, as shown in the illustrative embodiment of FIG. 11B, which shows a cross-section of an example passageway within a blade sonotrode. The supplementary material can be positioned on the side of the substrate facing the sonotrode 14B, while the fastener elements are formed from the side of the substrate facing the molding roller 14A. Although the passageways 30 are depicted as holes penetrating the blade sonotrode 2 in the embodiments of FIGS. 11A and 11B, in some embodiments, the passageways may instead take the form of channels serving to assist in guiding the supplementary materials to a desired location, as shown in the embodiment of FIG. 11C. In FIG. 11C, the passageways are shown to include channels 15 in the blade sonotrode apparatus 2 where supplementary materials 29 may be guided to said desired location.

As disclosed herein, the functional surface of a blade sonotrode may become excessively hot during processing the substrate material. This heat often is a result of friction associated with the substrate materials when the materials are in contact with the blade sonotrode functional surface as ultrasonic energy is applied. An excessively hot functional surface may impose limitations on the quality of the processed substrate, as the substrate may become damage or adhered to the functional surface of the blade sonotrode. Excessive heat may also limit the throughput speed of the ultrasonic formation of the fastener elements.

In some embodiments, additional materials with favorable heat transfer properties may be positioned between the functional surface of the blade sonotrode and the substrate to allow for increasing cooling of the functional surface during processing of the substrate. These materials may be of any suitable type, as this disclosure is not limited in this regard. The materials may be attached to the functional surface of the blade sonotrode through methods, including but not limited to, brazing, welding, spray coating, or mechanical fastening. In some embodiments, suitable additional materials may include, but are not limited to titanium carbide, aluminum, diamond, and/or copper coatings, or any other suitable material as the disclosure is not so limited. The inventors have recognized that the use of certain materials may provide advantages during processing of the substrate. For example, titanium carbide coatings or diamond coatings may be implemented when it is desirable for the sonotrode surface to have increased thermal conductivity, thereby promoting softening of the substrate material during processing. In another example, copper coatings may be implemented when it is desirable for the sonotrode surface to have reduced abrasion resistance, thereby reducing drag and friction associated with processing of the substrate. Embodiments of additional materials disclosed herein may also be incorporated into the functional surface of rotary sonotrodes.

In a further embodiment, the additional materials with favorable heat transfer properties may lack hardness or abrasiveness of a typical material used in the functional surface of a blade sonotrode, and therefore the materials may experience wear and require routine replacement. In a further embodiment, the material may also not be attached to the functional surface of a blade sonotrode and may instead be positioned between the blade sonotrode functional surface and the substrate material without being secured. This material may be intermittently positioned within the compression zone and then temporarily removed to permit intermittent cooling of the material. Moreover, the additional materials may take the form of a belt, flat disc, conical disc, or any other suitable shape configuration, as is apparent to one of skill in the art.

Aspects disclosed herein pertain to the use of continuous ultrasonic methods using a rotary or blade sonotrode to apply ultrasonic energy to a substrate to form fastener elements. In continuous ultrasonic methods, the ultrasonic energy from the sonotrode is continuously present. However, within the field of ultrasonics, there exists a noncontinuous method of ultrasonic formation that is commonly used for joining materials wherein the materials require cooling during processing. For example, a non-continuous method such as plunge welding of plastic components may be utilized by those of skill in the art for applications such as toys or automotive assemblies to maintain the welded assembly in a compressed state without applying ultrasonic energy for a given span of time to permit cooling of the welded materials. This method is commonly referred to as “Hold Time” by those of skill in the art of ultrasonics.

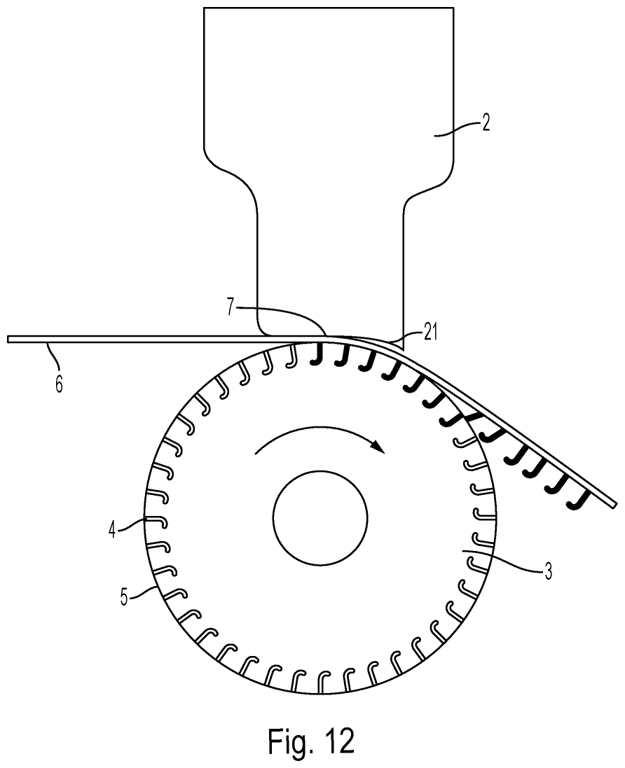

While aspects disclosed herein relate to continuous ultrasonic methods, the Inventors have recognized that altering the trailing edge of the functional surface of a blade sonotrode may permit cooling by reducing the contact area and ultrasonic energy applied to the substrate. In the illustrative embodiment of FIG. 12, a relieved area 21 may be provided in a functional surface 7 of a blade sonotrode 2. As shown in FIG. 12, a molding roller 3 with zones of fastener cavities 4 along the outer perimeter 5 may also be included to create a compression zone with the sonotrode to ultrasonically form incoming substrate material 6. The relieved area in the sonotrode functional surface may provide the incoming substrate material with sufficient time to cool by reducing the amount of ultrasonic energy applied to the substrate in select areas. This relieved area may therefore reduce the heat associated with the functional surface of the blade sonotrode and reduce the likelihood of the substrate material to adhere to the functional surface or become damaged.

In one embodiment, the functional surface of the blade sonotrode may also be cooled using a variety of methods including, but not limited to, the use of cooling air provided by blowers, compressed air, chilled compressed air, vortex cooling nozzles, or cryogenics. The blade sonotrode may be externally cooled or may be cooled by passing a cooling medium including, but not limited to compressed air, gases, or other fluid through cooling channels that can be machined into or onto the blade sonotrode.

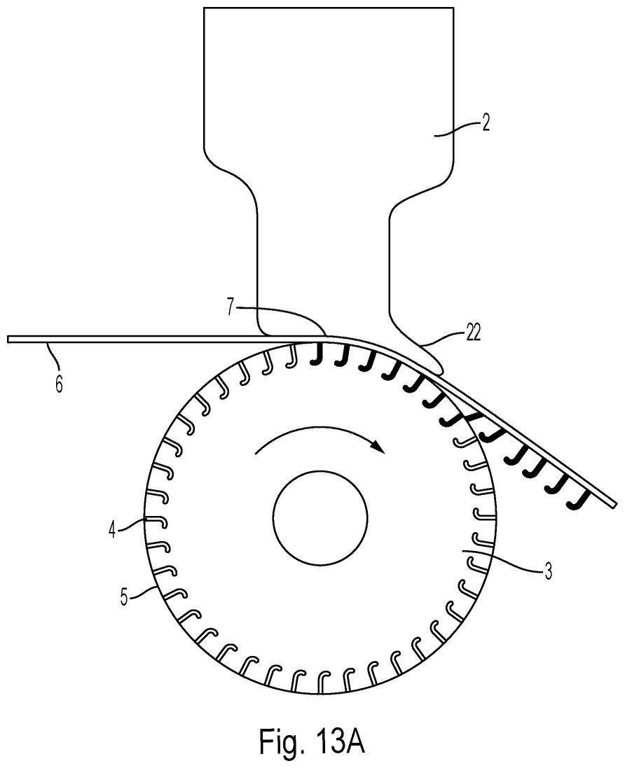

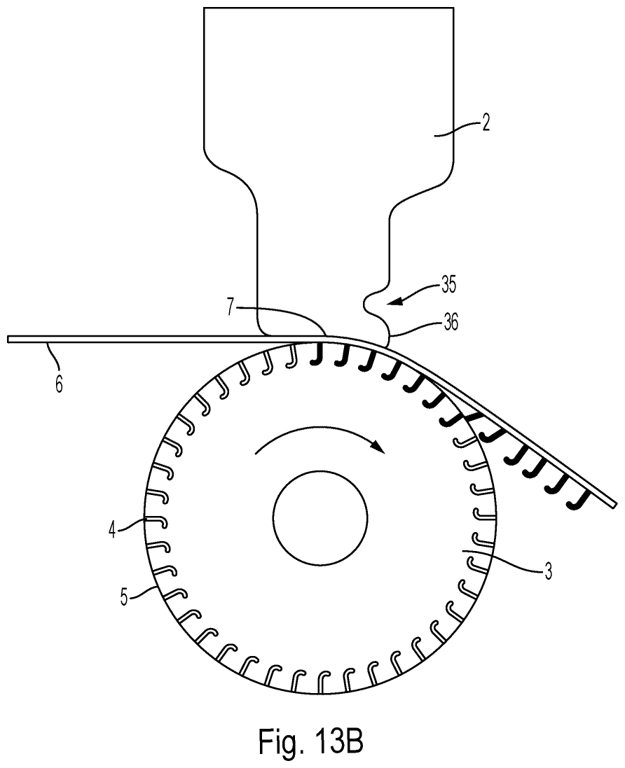

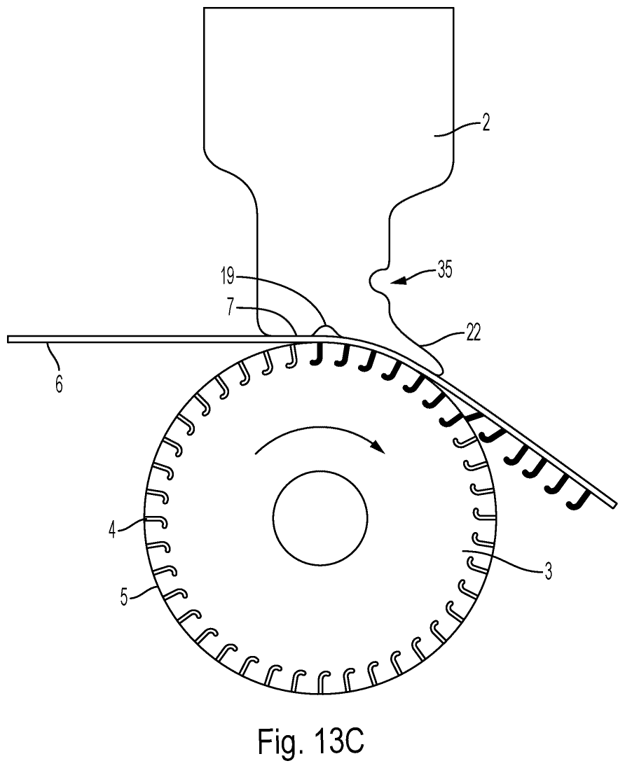

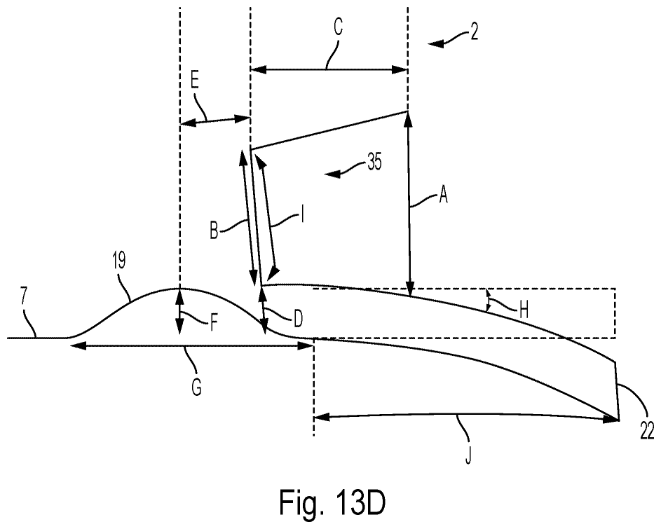

Additional features may be employed in the functional surface of the blade sonotrode to assist in cooling the sonotrode surface. These features may include, but are not limited to, raised fins, grooves, slots, or passages that may be machined into the functional surface of the sonotrode. Specifically, the functional surface 7 of a blade sonotrode 2 may be include an extension 22 along one or more sides, as is shown in the illustrative embodiment of FIG. 13A. As shown in FIG. 13A, a molding roller 3 with zones of fastener cavities 4 along the outer perimeter 5 may also be included to assist in forming of the fastener elements. The use of an extension 22 of the functional surface as shown serves to increase the amount of surface area exposed to the ambient environment of what is otherwise the warmest portion of the sonotrode. Therefore, the extension 22 serves to locally cool the sonotrode surface. The cooling associated with the extension 22 may serve to reduce adhesion of the substrate to the functional surface and may reduce or eliminate possible damage to the substrate during processing. In some embodiments, the sonotrode may be at least partially formed from a material having a poor thermal conductivity (e.g., titanium). In some such embodiments, the sonotrode surface may include an extension as detailed above, and the exposed portion of the extension may allow for application of more localized cooling using compressed air, cooled compressed air, or other means known to those skilled in the art and/or detailed herein.

In some embodiments, the inventors have recognized that the addition of an extension to the sonotrode surface may not be suitable for certain applications. For example, the use of an extension may not permit a desired acoustic response of the sonotrode during the application of ultrasonic energy. The use of an extension may also result in disturbances that are formed in the substrate post-processing as a result of the extension influencing the amount of energy that is applied to the substrate in a given location. In view of the above, the inventors have found that benefits may be realized by implementing a recessed portion located within the bounds of the functional surface of the sonotrode rather than an extension protruding past the bounds of the functional surface as detailed in FIG. 13A. In some embodiments, the recessed portion may be disposed along the side of the sonotrode, as shown in FIG. 13A. While in FIG. 13A only one recessed portion is shown, multiple recessed portions positioned within bounds of the sonotrode functional surface (e.g., two recessed portions opposing one another on each side of the sonotrode surface) may also be provided. These recessed portions may serve to provide less variation in the amount of energy applied to the substrate in comparison to the use of an extension detailed above. In FIG. 13B, a blade sonotrode 2 having a functional surface 7 with a recessed portion 35 is shown. The recessed portion 35 is formed in the functional surface 7 such that a tail portion 36 is provided. Since the tail portion 36 is formed within the bounds of the functional surface 7, the tail portion 36 may serve to apply consistent energy to the substrate 6 to reduce the number of disturbances formed in the substrate 6 post-processing while also permitting local cooling of the sonotrode surface through the recessed portion 35. As additionally shown in FIG. 13B, a molding roller 3 with zones of fastener cavities 4 along the outer perimeter 5 may be provided in conjunction with the blade sonotrode 2 to form fastener elements from the substrate 6. The recessed portion 35 and the corresponding tail portion 36 may be of any suitable size and/or shape such that the functional surface of the sonotrode applies consistent energy to the substrate while also permitting sufficient local cooling of the sonotrode surface through the exposed recessed portion.

In some embodiments, a combination of the features disclosed above may be implemented in a sonotrode as the disclosure is not so limited. For example, a sonotrode may include one or more recessed portions, one or more tail portions, and/or one or more grooves located in the functional surface. The embodiment of FIG. 13C shows such an arrangement with a blade sonotrode 2 having a functional surface 7 with a groove 19 disposed thereon. In FIG. 13C, a recessed portion 35 is shown in the side surface of the sonotrode 2 and a tail portion 22 is shown extending past the bounds of the functional surface 7. The sonotrode 2 is shown in conjunction with a molding roller 3 having zones of fastener cavities 4 along the outer perimeter 5 and a substrate 6 disposed between the functional surface 7 of the sonotrode 2 and the outer perimeter of the molding roller 5.

FIG. 13D shows a dimensioned schematic of a portion of the sonotrode 2 of FIG. 13C. The inventors have recognized that the grooves 19, recessed portions 35, and/or tail portions 22 may be selectively constructed and arranged to provide different sonotrode characteristics. For example, the size and/or shape of the recessed portion 35 and/or the tail portion 22 may influence the amount of cooling that is able to be provided on the sonotrode functional surface 7 or the structural integrity of the sonotrode 2 itself. The size and/or shape of the tail portion may also influence the amount of pressure applied to the incoming substrate. In another example, the size and/or shape of the one or more grooves may serve to assist in accumulating varying amounts of substrate material for filling zones of fastener cavities 4 to produce touch fasteners. The inventors have also recognized that the proximity of the recessed portions, tail portions, and/or grooves relative to one another may influence the aforementioned characteristics of the sonotrode. As such, the inventors have found benefit with certain dimensional parameters associated with these features as shown in FIG. 13D.

In FIG. 13D, dimensions A, B, and C refer to the outer recessed portion height, inner recessed portion height, and the recessed portion depth, respectively. In some embodiments, a suitable sizing for dimension A is greater than or equal to 1 mm, 3 mm, 5 mm, 10 mm, 15 mm, 20 mm, 25 mm, 30 mm, or greater. In some embodiments, a suitable sizing for dimension B is greater than or equal to 1 mm, 3 mm, 5 mm, 10 mm, 15 mm, 20 mm, 25 mm, 30 mm, or greater. Dimension B may also be 0 mm in some embodiments (e.g., if the recessed portion tapers from dimension A to dimension B). In a preferred embodiment, dimensions A and B may be 20 mm and 15 mm, respectively. The inventors have also recognized that the sizing of dimension C may be dependent on the width of the sonotrode itself. In some embodiments, a suitable sizing for dimension C is greater than or equal to 0.25 mm, 0.50 mm, 1 mm, 3 mm, 5 mm, 10 mm, 15 mm, 20 mm, 25 mm, 30 mm, or greater. FIG. 13D also includes dimension I, which depicts the corners of the recessed portion 35. The corners may be rounded, chamfered, or machined in any other suitable fashion as the disclosure is not so limited.

In FIG. 13D, dimensions F and G depict the height and width parameters of the groove 19 disposed in the functional surface 7. In some embodiments, a suitable sizing for dimension F is greater than or equal 0.01 mm, 0.05 mm, 0.10 mm, 0.50 mm, 1 mm, 3 mm, 5 mm, 10 mm, or greater. In some embodiments, a suitable sizing for dimension G may be greater than or equal to 0.50 mm, 1 mm, 3 mm, 5 mm, 10 mm, 15 mm, 20 mm, 25 mm, 30 mm, or greater. In a preferred embodiment, dimensions F and G may be 1 mm and 2 mm, respectively. FIG. 13D also shows dimension E which refers to the distance between the recessed portion 35 and the groove 19. In some embodiments, a suitable sizing of dimension E may be greater than or equal to 0 mm, 1 mm, 3 mm, 5 mm, 10 mm, 15 mm, 20 mm, 25 mm, 30 mm, or greater. The sizing of dimension E may also be lesser than or equal to 10 mm, 5 mm, 0 mm,-5 mm,-10 mm, or lesser, where a negative value denotes the groove being located past the inner height of the recessed portion along the functional surface 7 of the sonotrode 2.

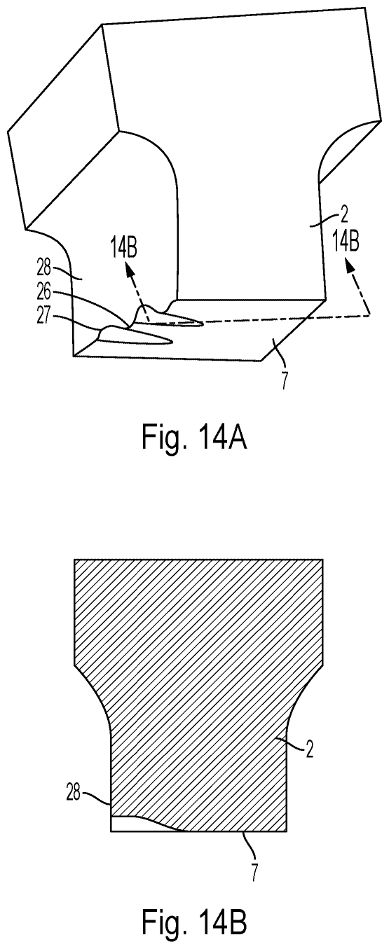

In addition, dimensions D and J refer to the height and the length of the tail portion 22, respectively. In some embodiments, a suitable sizing of dimension D is greater than or equal to 0.15 mm, 0.30 mm, 0.50 mm, 0.75 mm, 1 mm, 3 mm, 5 mm, 10 mm, 15 mm, 20 mm, 25 mm, 30 mm, or greater. In some embodiments, a suitable sizing of dimension J is greater than or equal to 5 mm, 10 mm, 15 mm, 20 mm, 25 mm, or greater. In a preferred embodiment, dimensions D and J may be 1 mm and 15 mm, respectively. In some embodiments, the tail portion 22 may be substantially curved as shown in FIG. 13D to match the curvature of a corresponding molding roller. In other embodiments, however, the tail portion 22 may be substantially parallel to a functional surface 7 of the sonotrode 2, as shown by the dotted lines in FIG. 13D. The inventors have also found that the radius of curvature H of the tail portion 22 may influence the cooling properties of the sonotrode 2 and the amount of ultrasonic energy that may be applied to a substrate during processing. In some embodiments, the inventors have recognized that the radius of curvature H is preferably slightly greater than the radius of a corresponding molding roller, thus allowing the tail portion 22 to maintain contact with a corresponding substrate to prevent enlargement of the substrate post-processing. In particular, enlargement refers to the tendency of the substrate to expand if the compression on the substrate isn't sufficiently maintained during processing and cooling. While these dimensional parameters have been disclosed in embodiments above, any suitable dimensional parameter may be implemented for each of the recessed portion, the tail portion, and/or the grooves. Also, in some embodiments, not all of these features may be present. For example, a groove and a recessed portion, but no tail portion, may be provided in the sonotrode. In an illustrative embodiment of FIG. 14A, linear ribs 26 or channels 27 may be provided in the functional surface 7 of the blade sonotrode 2. A cross-section view of FIG. 14A is shown in FIG. 14B to detail one embodiment of the linear ribs disposed on the functional surface of the blade sonotrode. Specifically, the linear ribs and channels may be located along the incoming portion 28 of the blade sonotrode where the sonotrode would not yet induce sufficient ultrasonic energy to soften the substrate. These linear ribs or channels may be directed in the machine-direction, which is the direction facing the incoming substrate material. The linear channels may serve to reduce the initial surface contact area between the incoming substrate material and the functional surface of the blade sonotrode, which may be beneficial in reducing friction and heat associated with the functional surface. The tapered nature of the linear channels may also serve to apply gradual ultrasonic energy to the substrate as the incoming substrate material passes the trailing end of the channel and enters the adjacent region of the functional surface 7.

An additional limitation that may occur in the use of a blade sonotrode for the ultrasonic formation of fastener elements is that it may be difficult to accurately position the blade sonotrode in relation to the molding roller during continuous use. Specifically, when using a molding roller with intermittent raised patches of fastener cavities in conjunction with a blade sonotrode, maintaining the positioning of the blade sonotrode may prove particularly difficult. This limitation may occur as a result of the blade sonotrode applying a radial force to the molding roller as it rotates. As such, in embodiments where the molding roller contains intermittent patches of fastener cavities, the patches on the molding roller may abruptly contact the functional surface of a blade sonotrode, resulting in disruption or displacement of the positioning of the functional surface.

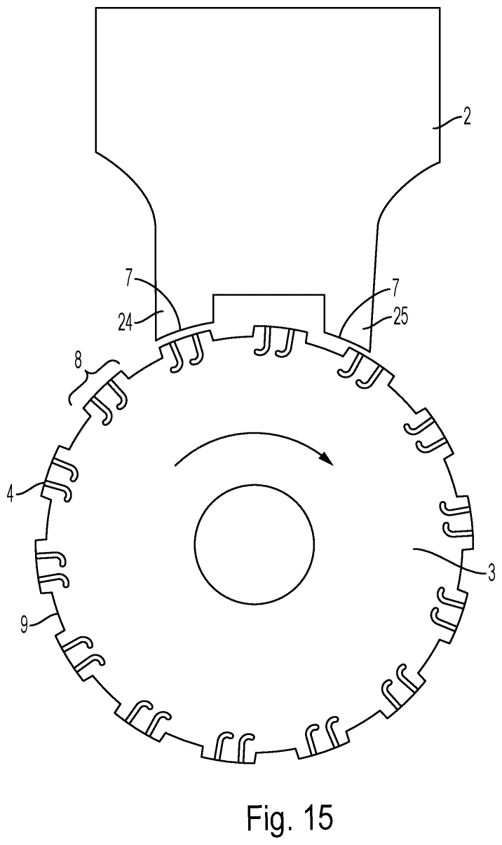

The Inventors have further recognized and appreciated that it may be beneficial to provide features to the blade sonotrode functional surface that reduce or eliminate the aforementioned limitation. In an illustrative embodiment of FIG. 15, it is shown that a blade sonotrode 2 may include a functional surface 7 of the blade sonotrode that bridges across the intermittent zones 8 of fastener cavities 4 on the molding roller 3 as it rotates. The zones of fastener cavities may be raised above the outer surface 9 of the molding roller. This illustrative embodiment further details a leading portion 24 and a trailing portion 25 of the functional surface that maintains contact with at least portions of two or more raised patches of fastener cavities. The leading and trailing portions may be of any suitable size, shape, or other characteristic as the disclosure is not limited in this regard. These features are beneficial in that they may reduce or eliminate the disruptions of the blade sonotrode in the radial direction.

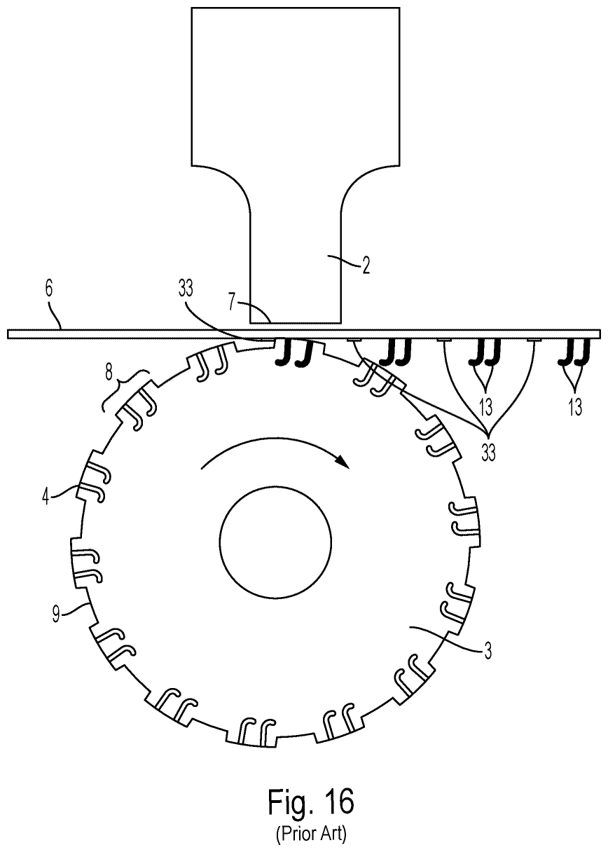

The inventors have also recognized that, in some embodiments, the use of a blade sonotrode may result in regions of surplus material being deposited along the postprocessed substrate material. Specifically, in using a molding roller with intermittent patches of fastener cavities (see FIG. 2), surplus material may be deposited adjacent to portions of the substrate where touch fasteners are formed as a result of the applied ultrasonic energy from the blade sonotrode smearing portions of the softened substrate, as shown in FIG. 16. The resulting surplus material may provide undesirable contours, unaesthetic visuals, and/or rough textures to the substrate surface which may cause discomfort to the end user in applications such as diapers. The post-processed substrate may also become more rigid due to the surplus material and/or the substrate material may become damaged (e.g. holes in the substrate) resulting from the surplus material melting through the substrate. While the disclosure above discusses deposits of surplus material resulting from use of a blade sonotrode, the inventors have also found that surplus material may also be deposited from use of a rotary sonotrode.

FIG. 16 depicts a prior art arrangement of a blade sonotrode 2, a substrate material 6, and a molding roller 3. The functional surface 7 of the blade sonotrode 2 may apply ultrasonic energy to form touch fasteners 13 from the substrate material 6 using touch fastener cavities 4 formed on intermittent patches 8 of the molding roller 3. The intermittent patches 8 may be raised above the outer perimeter 9 of the molding roller 3 to selectively contact the compressive zone formed with the functional surface 7 of the blade sonotrode. In this process, surplus material 33 may form on regions of the substrate 6 adjacent to the formed touch fasteners 13. While the surplus material 33 is shown in this arrangement as being positioned on the trailing-edge of the formed touch fasteners, the surplus material may also be deposited along the leading-edge, side edges, or any portion of the perimeter of the formed touch fasteners.

In view of the foregoing, the inventors have recognized and appreciated that the dimensional parameters of the intermittent patches formed on a molding roller may be modified and that such patches may include textured surfaces to reduce the accumulation of surplus material on the substrate surface. For example, the length of the patches may be increased to provide what is hereinafter referred to as a “runoff zone”. The runoff zone may include textured surfaces with any suitable size, shape, pattern, or other characteristic to reduce accumulation of the surplus material.

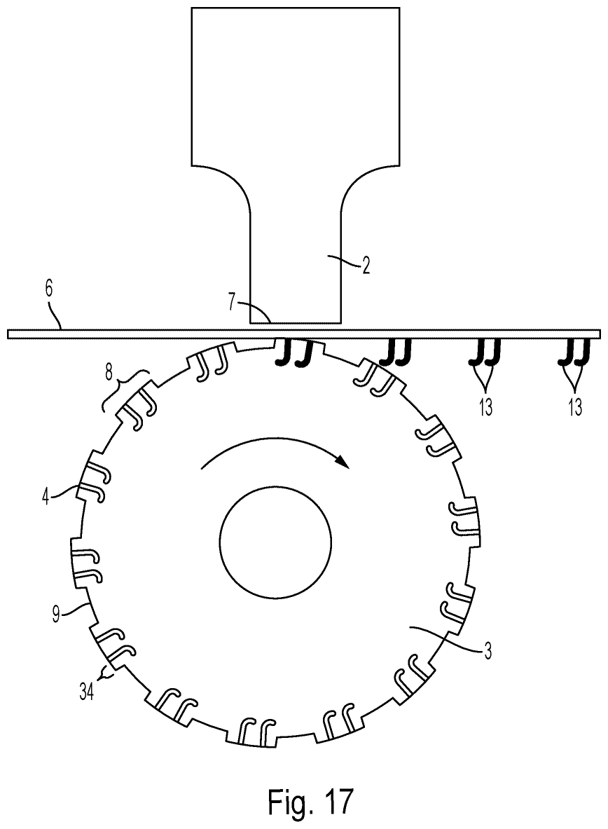

FIG. 17 depicts an illustrative embodiment of a blade sonotrode 2 having a functional surface 7, a substrate material 6, and a molding roller 3 including intermittent patches 8 of fastener cavities 4 raised above the outer perimeter 9. The intermittent patches 8 include runoff zones 34 which may be provided with a textured surface. The runoff zones 34 may serve to collect the surplus material that would otherwise accumulate on the substrate 6 due to application of ultrasonic energy to form touch fasteners 13. The collected surplus material may be deposited within the textured surface in a controlled pattern, thereby reducing accumulation of surplus material on the substrate and promoting flexibility of the post-processed substrate. While the runoff zones 34 are shown as being positioned on the trailing-edge of the patches 8, the runoff zones 34 may also be positioned on the leading-edge of patches 8 or the perimeter of patches 8 as disclosed above.

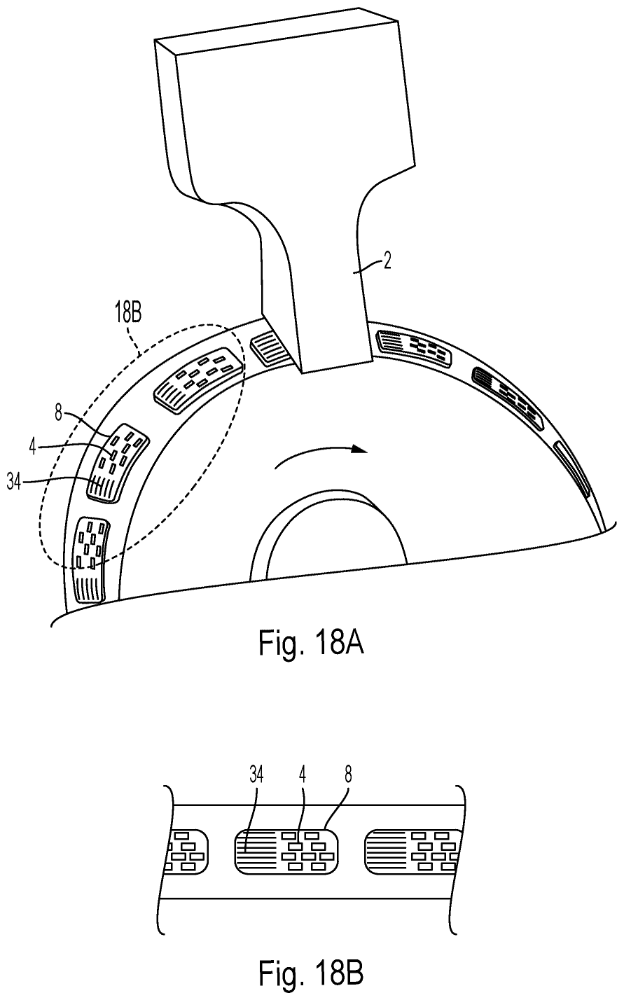

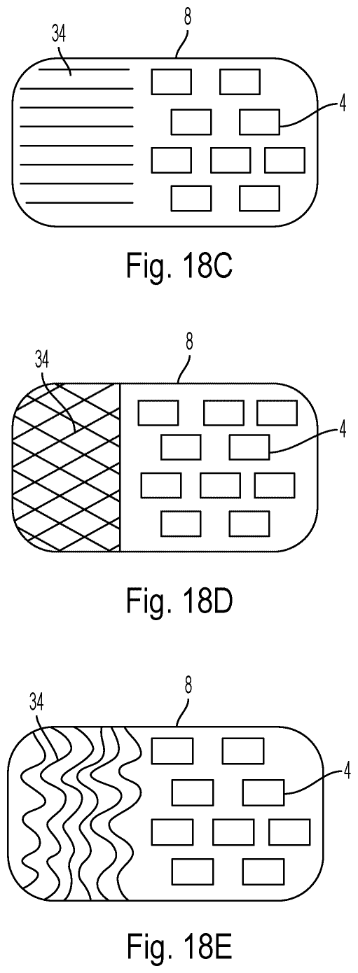

FIG. 18A depicts a perspective view of the illustrative embodiment of FIG. 17 without substrate material to show the intermittent patches 8 of fastener cavities 4 and the runoff zones 34 included in the patches 8 adjacent to the cavities 4. FIG. 18B shows an enlarged radial view of region 18B of FIG. 18A.

FIGS. 18C-18E depict certain embodiments of intermittent patches 8 having fastener cavities 4 and runoff zones 34. FIG. 18C shows a runoff zone with a lined pattern, FIG. 18D shows a runoff zone with a crosshatch pattern, and FIG. 18E shows a runoff zone with a wavy pattern. While these configurations are disclosed, the runoff zones may be of any suitable texture, size, shape, and pattern such as checkerboard, stripes, circular, oval, annular, polygonal (square or rectangular shapes), or any other suitable pattern or other shape or combinations thereof as the disclosure is not so limited.

As disclosed above, the use of runoff zones may extend the perimeter of the intermittent patches on a molding roller. In some embodiments, a suitable length or overhang of a runoff zone may be greater than or equal to 1 mm, 2 mm, 3 mm, 5 mm, 10 mm, 15 mm, 20 mm, 25 mm, 30 mm, 35 mm, 40 mm, 45 mm, 50 mm, or greater.

In some embodiments, the runoff zones may include raised and/or lowered textures. For example, a runoff zone may include a textured pattern in a crosshatch configuration where some of the textures are recessed into the substrate while other textures are heightened relative to the base of the substrate. The textures may be raised any suitable height including greater than or equal to 0.1 mm, 0.2 mm, 0.3 mm, 0.4 mm, 0.5 mm, 0.7 mm, 1 mm, 1.5 mm, 2 mm, or greater. The textures may also be lowered at any suitable depth including greater than or equal to 0.1 mm, 0.2 mm, 0.3 mm, 0.4 mm, 0.5 mm, 0.7 mm, 1 mm, 1.5 mm, 2 mm, or greater.

The inventors have also found that, in some embodiments, benefits may be realized by providing a textured pattern to a runoff zone that is substantially similar to the existing pattern of the substrate material. Such a configuration may serve to reduce the appearance of the textured portions on the substrate material itself that would result from ultrasonic energy being applied to the substrate in the compression zone. For example, in embodiments where a non-woven material is used as the substrate material with the nonwoven material being fibrous, a randomly textured pattern that blends well with the fibrous appearance of the non-woven material may improve the aesthetics of the postprocessed substrate.

The inventors have recognized benefits associated with mounting a sleeve onto an outer surface of a roller, which may then be used in conjunction with the application of ultrasonic energy from a sonotrode to produce touch fasteners. Such benefits include that sleeves may provide a cheaper, easily customizable alternative to zones of fastener cavities formed of molding rings mounted to a roller, and that a mountable sleeve may allow for the easier production of wider tooling which can produce touch fasteners at a greater rate. The type of touch fasteners which may be produced from a sleeve mounted on a roller include, for example, mushroom-like fasteners having an hourglass shape. While such fastener types are disclosed, any suitable fastener shape and size may be produced from a sleeve mounted onto a roller. Moreover, the sleeve may be constructed and arranged in any suitable fashion to permit mounting to the roller. In some embodiments, the sleeve may be a tubular such that the sleeve may be secured around the circumference of the roller. In other embodiments, however, a sleeve may be secured to only a portion of the circumference of the roller as the disclosure is not so limited.

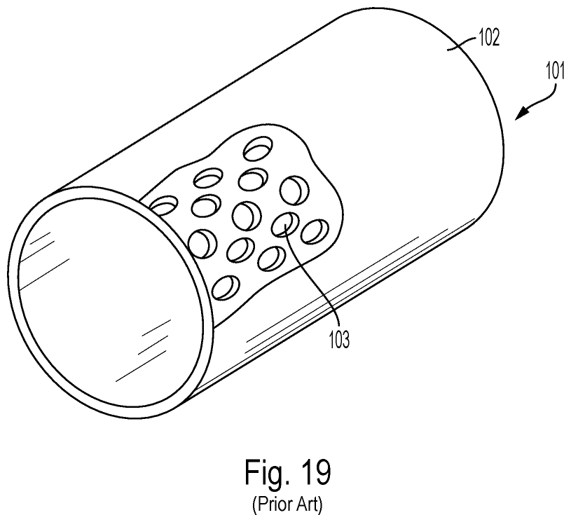

An example of a prior art sleeve arrangement configured for use with manufacturing fastening elements is disclosed in U.S. Pat. No. 6,287,665 B1, the disclosure of which is incorporated by reference herein in its entirety. An example of this prior art arrangement is shown in reference to FIG. 19, which depicts a sleeve 101 formed of a screen 102 having molding openings 103. The inventors have found that the use of ultrasonics to manufacture touch fasteners using a molding roll formed of a such a sleeve 101 mounted to a roll, hereafter referred to as a sleeve molding roll (note: the roll is not shown in FIG. 19) would be beneficial.

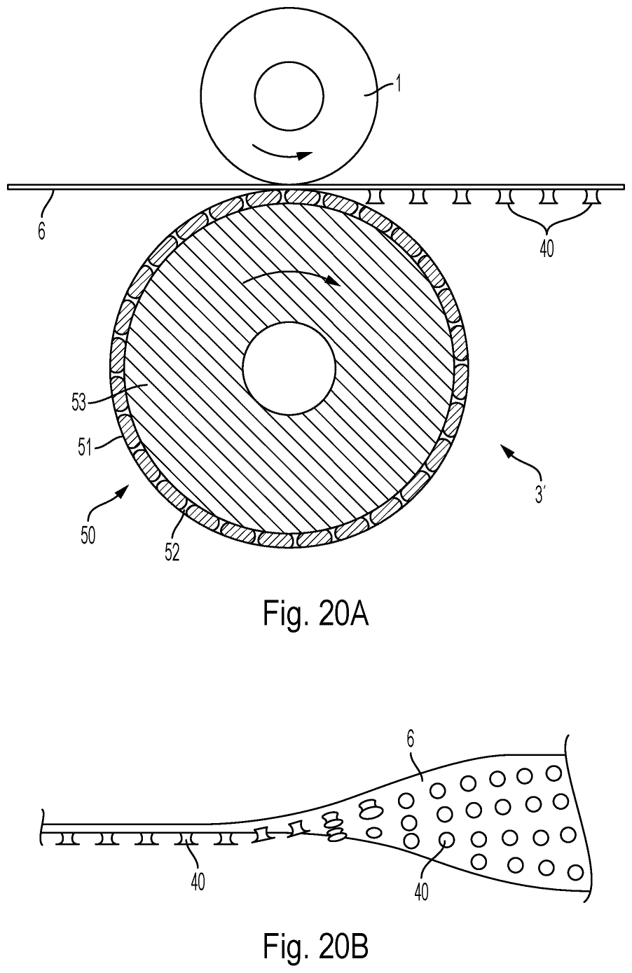

In some embodiments, a rotary sonotrode may be used in applying ultrasonic energy to a sleeve molding roller to produce touch fasteners, as is shown by the exemplary arrangement of FIG. 20A. In FIG. 20A, the arrangement includes a rotary sonotrode apparatus 1, a sleeve molding roller 3′, and a substrate 6. In the depicted embodiment, the molding roller 3′ is formed of a sleeve 50 that includes screen 51 having screen cavities 52 extending around the circumference of the screen 51. The sleeve 50 is also secured onto the roll 53. The cavities may be of any suitable shape and size but are shown to be formed in an hour-glass shape in FIG. 20A. As the substrate 6 is fed through the contact area between the rotary sonotrode 1 and sleeve molding roll 3′, portions of the substrate 6 may be forced into the cavities 52 through the application of ultrasonic energy from the sonotrode. This process may result in touch fasteners projecting from the substrate surface post-processing, which are shown in FIG. 20A as ovalized mushroom-like touch fasteners 40. While a rotary sonotrode is described in reference to FIG. 20A, other suitable sonotrodes including blade sonotorde apparatuses may be used as the disclosure is not so limited.

FIG. 20B shows a perspective view of the substrate which may result from the arrangement of FIG. 20A post-processing. FIG. 20B shows an array of mushroom fasteners 40 extending from the substrate 6. As noted herein, the use of a sleeve molding roller may be customizable such that the width of the sleeve 50 in the cross machine direction can be altered to increase the number of fasteners produced during manufacturing.

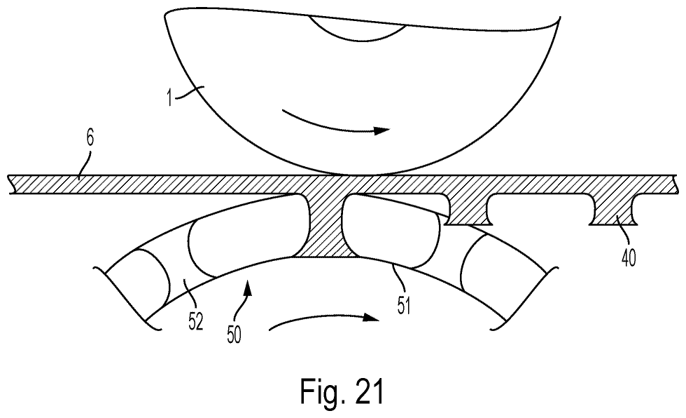

FIG. 21 shows an enlarged view of the contact area between a rotary sonotrode apparatus 1 and a sleeve 50. In this embodiment, the substrate 6 is a film-like material which may be fed into the contact area between the sonotrode and the sleeve 50 to force portions of the substrate 6 into the screen cavities 52 of the screen 51, resulting in the formation of a plurality of mushroom fasteners 40 formed thereon. Due to the nature of the film-like material of the substrate 6, the fasteners 40 and substrate 6 may provide a resulting product which is substantially homogenous due to the substrate being constructed of a polymer or a similar film-like material.

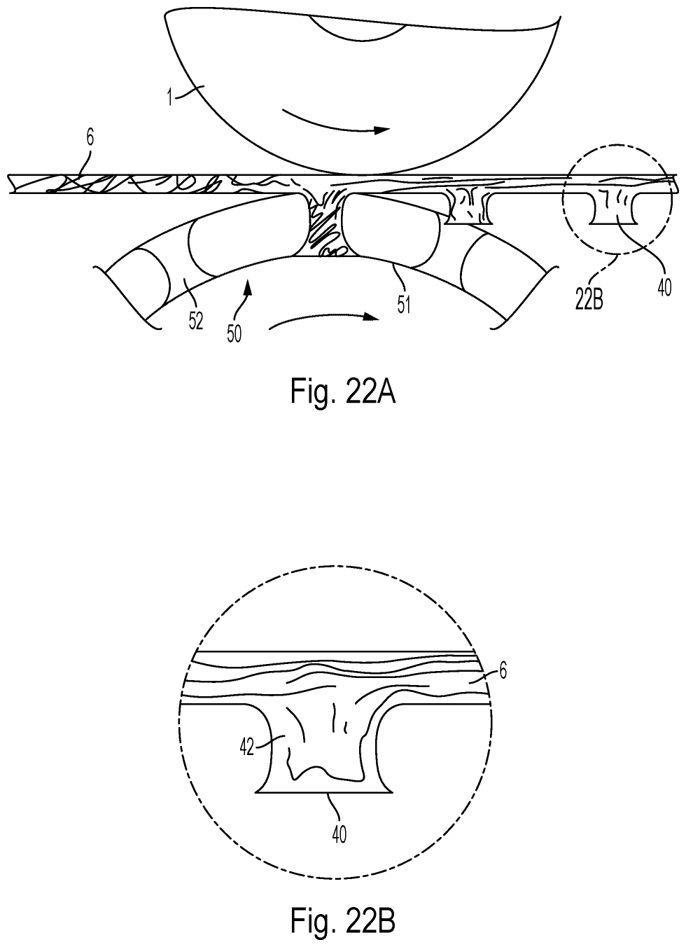

FIG. 22A shows another embodiment of FIG. 21. In this embodiment, the substrate 6 is a fibrous or at least partially fibrous material which may be fed into the contact area between the sonotrode and the sleeve to force portions of the substrate 6 into the screen cavities 52 of the screen 51, resulting in the formation of a plurality of mushroom fasteners 40 formed thereon. In some embodiments, due to the relatively large, rounded entrance openings of the screen cavities 52, some of the fibers may not be melted during the ultrasonic process. In particular, the large opening due to the hourglass shape of the screen cavities 52 may provide minimal or no support during localized compression of the substrate following the application of ultrasonic energy, which may result in the substrate not being fully melted. The inventors have recognized that such an arrangement may provide additional strength to the resulting fasteners 40 to aid in securing the fasteners 40 to the base of the substrate 6 post-processing. In some embodiments, however, if it is not desirable to have resulting fasteners which are fibrous and/or not fully melted, the surface speed of the rotary sonotrode apparatus 1 may be set differentially from the surface speed of the sleeve 50 mounted on the molding roller to scrape surplus molten material from the substrate 6 into the screen cavities 52. FIG. 22B shows an enlarged view of region 22B of FIG. 22A where a single fastener 40 formed on the substrate 6 is shown. As can be seen in FIG. 22B, fibrous elements 42 of the substrate 6 may remain intact following the formation of the fastener 40.

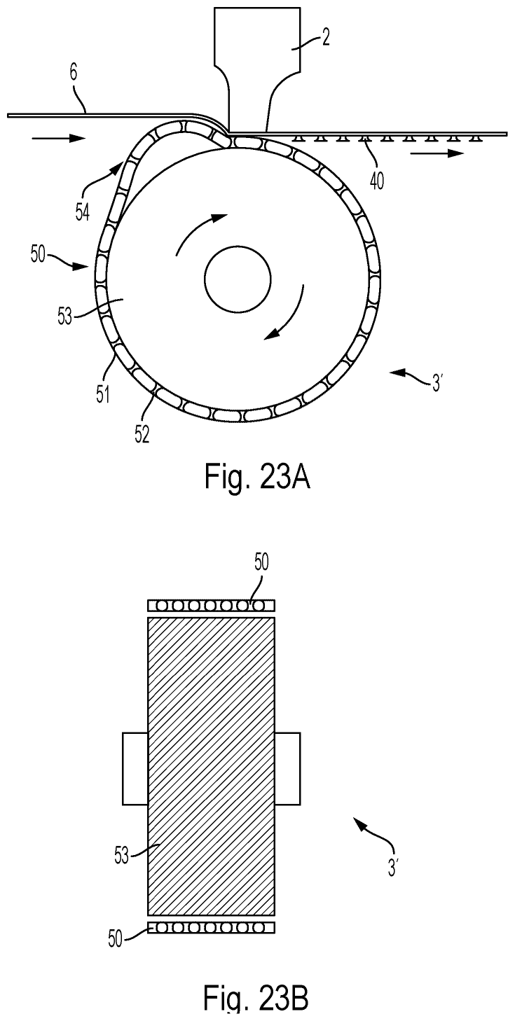

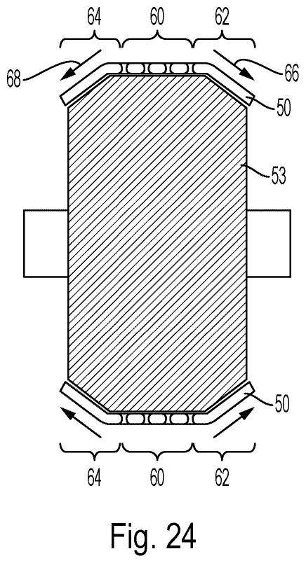

FIG. 23A shows an embodiment of a blade sonotrode apparatus 2 configured for use with a molding roller 3′ having a sleeve 50 secured on a roll 53. As above, the sleeve 50 includes a series of screen cavities 52 which are arranged around a circumference of the screen 51. During processing, a substrate 6 which may be any suitable material as disclosed herein, may be fed through a contact area between the blade sonotrode 2 and the molding roll 3′ to force portions of the substrate 6 into the screen cavities 52, resulting in a plurality of fasteners 40 being formed on and projecting from the substrate 6.

FIG. 23B depicts a cross-sectional view in which the molding roller 3′ is shown. In some embodiments, outer surface of the roll may be smooth. In another embodiment, the roll may be textured to create passages between portions of the inner surface of the sleeve 50 and the outer surface of the roll 53. Such an arrangement may allow for the venting of air from the cavities formed in the screen 51 as the cavities are filled with substrate during ultrasonic processing.

In some such embodiments, the sleeve 50 may have been mounted to the molding roller by stretching the sleeve 50 over the roller 53. The inventors have found that a humped region 54 may occur during ultrasonic processing of the substrate, as shown in FIG. 23A, due to this mounting arrangement. This humped region 54 may occur due to shear forces applied to the sleeve 50 during rotation of the molding roller 3′, which in turn separates a portion of the sleeve 50 from the roller 53 to which it is mounted.

FIG. 24 shows an embodiment of a molding roller 3′ having an improved sleeve mounting arrangement. The sleeve 50 may be stretched over the roll 53, and one or more of the sides of the roll 53 may be tapered such that the sleeve 50 may more easily grip the roll 53 to reduce the likelihood of disengagement between the sleeve 50 and roll 53. The sides of the roll 53 may be chamfered, filleted, or be of any other suitable edge design as the disclosure is not so limited. Accordingly, the sleeve 50 may be described as having a plurality of sections interfacing with different portions of the roll 53. In FIG. 24, the sleeve 50 includes a first section 60, a second section 62, and a third section 64. In this exemplary embodiment, the first section 60 includes screen cavities into which portions of a corresponding substrate will be forced to form fasteners while second and third portions (62, 64) are secured to the tapered sides of the roll 53. The sleeve 50 may be at least partially elastomeric such that there may be resultant forces along the tapered sides of the roll 53 (denoted by arrows 66 and 68, respectively) that are caused by the contraction of the sleeve 50 following mounting of the sleeve to the roll 53. The inventors have recognized that by including the tapered sides of the roll 53, the corresponding bending of the sleeve 50 and the resulting geometry may reduce the tendency of the sleeve 50 to hump in response to shear forces during processing of the substrate.

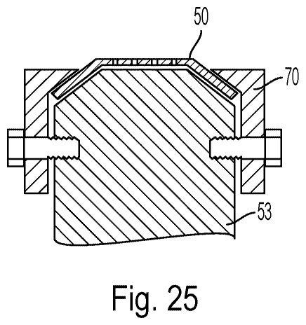

FIG. 25 shows another embodiment where the sleeve 50 is further secured to the roll 53 with fastening features 70. The fastening features 70 may be of any suitable type including but not limited to a bolted clamp-like connection as shown in FIG. 25. The use of fastening features 70 may provide additional tensioning to the sleeve 50 to reduce the likelihood that humped regions develop during processing of the substrate (e.g., sections where the sleeve disengages from the roll).

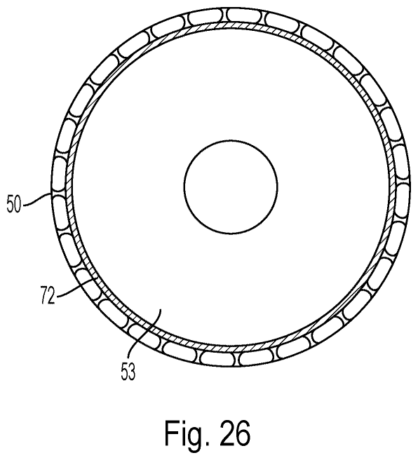

FIG. 26 shows another embodiment for mounting the sleeve 50 onto the roll 53 using a variety of suitable arrangements including, but not limited to adhesive, brazing, soldering, or mechanical fastening as the disclosure is not so limited. The sleeve 50 may also be attached using spot welding via lasers, electron beams, or other suitable methods known to those skilled in the art. In some embodiments, the sleeve 50 may also be detached from the roll 53 through use of heat, chemicals, or other suitable methods as the disclosure is not so limited. In the embodiment of FIG. 26, the sleeve 50 is shown to be attached to the roll 53 via an adhesive 72 positioned between the screen 50 and the roll 53. As disclosed above, the outer surface of the roll may textured to create passages which allow for the venting of air from the cavities as the cavities are filled with processed substrate. In this respect, the adhesive should be located or configured to not obstruct the venting.

It should be appreciated that the foregoing description may employ the improved ultrasonic formation methods as well as rotary and/or blade sonotrode improvements disclosed herein for use in forming fastener elements for a variety of product applications. These product applications include, but are not limited to, adult and infant disposable diapers, incontinence products, hygiene products, medical products, bristles, pins, scraping blades, and disposable cleaning products. The foregoing description may also be employed in ultrasonic bonding and texturing applications wherein the foregoing features may be useful to improve, quality, yield, and production efficiencies.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

While the present teachings have been described in conjunction with various embodiments and examples, it is not intended that the present teachings be limited to such embodiments or examples. On the contrary, the present teachings encompass various alternatives, modifications, equivalents, as will be appreciated by those of skill in the art. Accordingly, the foregoing description and drawings are by way of example only.

1. A system for ultrasonically forming touch fasteners, the system comprising:
a sonotrode having a functional surface; and
a molding roller having a plurality of fastener cavities;
wherein the sonotrode has a plurality of raised and/or recessed features disposed on the functional surface of the sonotrode, and wherein the plurality of raised and/or recessed features are configured to apply ultrasonic vibrations to a substrate that is to be disposed between the functional surface and the molding roller to progressively form touch fasteners from the substrate.

2. The system of claim 1, wherein the sonotrode is a rotary sonotrode.

3. The system of claim 1, wherein the sonotrode is a blade sonotrode.

4. The system of claim 1, wherein the plurality of raised and/or recessed features are configured to produce undisturbed portions in the substrate.

5. The system of claim 1, further comprising one or more supplementary materials, wherein the one or more supplementary materials is configured to be disposed between the substrate and the functional surface of the sonotrode and/or between the substrate and the molding roller.

6. (canceled)

7. The system of claim 3, wherein the blade sonotrode includes one or more passageways disposed therein, with the passageways configured to receive a supplementary material and guide the material to a desired region between the functional surface and the molding roller.

8-14. (canceled)

15. The system of claim 2, wherein the rotary sonotrode and the molding roller are driven in a fixed ratio.

16. The system of claim 2, wherein the rotary sonotrode and the molding roller are driven in a varied ratio.

17. The system of claim 2, further comprising one or more rollers positioned around a perimeter of the rotary sonotrode, wherein the one or more rollers are configured to pre-heat the substrate.

18. (canceled)

19. The system of claim 1, wherein the plurality of raised and/or recessed features disposed on the functional surface are formed as channels.

20. (canceled)

21. The system of claim 3, wherein the plurality of raised and/or recessed features include a relieved portion in the functional surface.

22. The system of claim 3, wherein the functional surface is extended in a substantially similar direction to a circumference of the molding roller.

23. The system of claim 3, wherein the molding roller includes a plurality of patches having fastener cavities, and wherein the plurality of raised and/or recessed features include a plurality of raised features configured to span at least a portion of at least two of the plurality of patches during rotation of the molding roller.

24. The system of claim 1, wherein the molding roller includes one or more patches having a plurality of fastener cavities and an adjacent runoff zone.

25. The system of claim 24, wherein the runoff zone includes one or more textured surfaces configured to collect surplus material during forming of the touch fasteners.

26. The system of claim 25, wherein the textured surfaces are of a pattern selected from at least one of a cross hatch pattern, a wavy pattern, a checkerboard pattern, a striped pattern, a circular pattern, an oval pattern, an annular pattern, a square pattern, and a rectangular pattern.

27. The system of claim 25, wherein at least a portion of the one or more textured surfaces is recessed into the surface of the runoff zone.

28. The system of claim 25, wherein at least a portion of the one or more textured surfaces is raised above the surface of the runoff zone.

29. The system of claim 3, wherein the plurality of raised and/or recessed features include a recessed portion disposed along a side of the sonotrode functional surface.

30. (canceled)

31. A system for ultrasonically forming touch fasteners, the system comprising:
a rotary sonotrode having a functional surface; and
a molding roller having a plurality of fastener cavities;
wherein the functional surface of the rotary sonotrode is configured to apply ultrasonic vibrations to a substrate that is to be disposed between the functional surface and the molding roller to form touch fasteners from the substrate, wherein the rotary sonotrode has one or more raised and/or recessed features disposed on the functional surface, and wherein the rotary sonotrode and the molding roller are driven in a varied ratio.

32-52. (canceled)
